(19) United States
(12) Patent Application Publication
(10) Pub. No.: US 2002/0114884 A1
(43) Pub. Date: Aug. 22, 2002

(54) Process for applying a coating to a continuous steel sheet and a coated steel sheet product therefrom

(76) Inventors: Fritz J. Friedersdorf, Hellertown, PA (US); Michael J. Danilich, Bethlehem, PA (US); Theresa C. Simpson, Hatfield, PA (US)

Correspondence Address: Harold I. Masteller, Masteller Patent Services, Inc., P.O. Box 302, Springtown, PA, 18081, US

(21) Appl. No.: 09/942,955

(22) Filed: Aug. 31, 2001

Related U.S. Application Data
(60) Provisional application No. 60/229,949, filed on Sep. 1, 2000.

(51) Int. Cl. B05D 3/02; B05D 1/36; B05D 1/28; B05D 3/06; B05D 1/04

(52) U.S. Cl. 427/195; 427/428; 427/407.1; 427/475; 427/327; 427/557; 427/558; 427/551; 118/314

(57) ABSTRACT

A process is disclosed for applying an organic high solids finish coating to a preprimed metallic coated steel sheet. The resulting process is environmentally efficient, cost effective and yields a durable finish coated steel sheet article. The process also includes steps for applying a metallic coating and an organic primer in a single continuous process to form a preprimed steel sheet article. The primer may be a waterborne coating that is applied directly to the pristine metallic coated sheet.

This present application claims the benefit of Applicants' U.S. Provisional Patent Application No. 60/229,949, filed Sep. 1, 2000.

### FIELD OF THE INVENTION

The disclosed invention relates to an improved coil coating process for applying organic coatings to hot-dip coated or electroplated steel sheet, the improved coil coating process eliminating various steps associated with conventional hot-dip coating or electroplating and subsequent coil coating processes. The elimination of the process steps reduces line space requirements, reduces capital costs for equipment, lowers chemical and power consumption, and eliminates various waste streams associated with the eliminated processing steps. In particular, the improved coil coating process is directed to applying a prime coat to the sheet in the continuous hot-dip coating or electroplating line operation, thereby eliminating steps with a potentially significant and detrimental environmental impact, such as chemical passivation, oiling, edge sealing and packaging with vapor phase corrosion inhibitor (VCI) film. Additionally, the improved coil coating process delivers prime-coated sheet directly from the hot-dip coating or electroplating operation to the subsequent coil coating operation. This further reduces environmental impact through the elimination of various additional brushing, cleaning and pretreatment steps, as well as their associated waste streams.

### BACKGROUND OF THE INVENTION

Conventional coil coating lines require a large amount of space and have high capital and operating cost. Conventional coil lines can be over 800 ft (240 m) long and housed in 250,000 ft² (23,000 m²) facilities. Including accumulator towers and line length, a conventional coil coating line may have 2,000 ft of strip between the entry and exit ends of the coil coating line. Significant portions of line space, capital cost and operating cost are dedicated to environmental control equipment and the cleaning and pretreatment sections. A coil coating facility may cost as much as $50,000,000 dollars to construct and $4,000,000 to $12,000,000 to operate annually. Coil coating facilities are economically viable primarily for large orders providing for long run times on similar products. These lines are best suited to directly servicing large consumers of prepainted steel sheet and/or large geographical areas. The delivery times are severely constrained by shipping and scheduling activities. Only large prepainted sheet consumers are capable of efficiently owning and operating a coil coating facility, while other prepainted sheet consumers utilize fee for service (toll) coil coating facilities.

Conventional coil coating of continuous hot dip coated or electroplated steel sheet requires several intermediate steps at the hot dip coating or electroplating line whose functions are to reduce the reactivity of the sheet surface and provide sufficient resistance to degradation or corrosion of the coated steel sheet during storage and transport prior to painting at the remotely located coil coating line. It also requires several intermediate steps at the coil coating line whose functions are to regenerate a reactive metal or metal alloy coating surface for painting by deliberately overcoming the protective steps taken at the hot dip coating or electroplating line. Such intermediate steps are inefficient and do not improve the quality or performance of the finished (coil-coated) product. In addition, these intermediate steps consume energy, waste heat, and generate solid, liquid, and airborne pollutants that may adversely impact health and safety in the workplace and surrounding environment. Furthermore, application and curing or drying of conventional paints at the coil coating line generates airborne pollutants that must be handled appropriately.

For example, intermediate process steps taken at the hot dip coating or electroplating line to reduce surface reactivity and provide corrosion resistance during storage and transport to the coil coating line include chemically passivating, oiling, edge sealing, and packaging the steel in paper or plastic that contains vapor phase corrosion inhibitors. Chemical passivation involves application of a solution by immersion, spray and squeegee, or roll coater equipment and subsequent drying using a hot air blower or drying oven. Typical chemical passivates are highly acidic (pH 1-2) and contain hexavalent chromium, considered by the Environmental Protection Agency to be carcinogenic. The chemically passivated sheet is often subsequently coated in line with oil that contains volatile organic compounds and corrosion inhibitors, such as barium sulfonate and calcium sulfonate.

Because the oils and passivates applied at the hot dip coating or electroplating line are detrimental to paint adhesion, a number of process steps are required at the remotely located coil coating facility to remove these materials and regenerate a reactive surface before the hot-dip coated or electroplated steel sheet can be painted. These process steps may include spraying the hot dip coated or electroplated sheet with a hot aqueous alkaline solution, mechanical cleaning by abrasive brushing to remove more tenaciously adhered contaminants and surface oxides, a final chemical cleaning, and water rinsing. Such steps involve alkaline chemicals, substantial quantities of water and substantial amounts of power to heat solutions and to drive the pumps and brushes. The cleaning process is designed to remove tramp oils and contaminants, as well as the deliberately applied chemical passivation, which may include soluble and insoluble chromium, zinc, and other compounds, oils, corrosion inhibitors, and edge sealants.

Abrasive brushing produces particulate waste containing the hot-dip coated or electroplated metals and chromium compounds from the chemical passivate. The mists and vapors from the cleaning process typically are isolated and removed from the work environment because of the presence of hexavalent chromium compounds in the used cleaning solutions. The aqueous waste stream has a high pH and contains oils, metal particles, and heavy metal ions in solution. The waste streams discharged by such cleaning operations may pose environmental, health and safety risks and must be handled, treated, and disposed of properly.

Despite steps to regenerate a reactive metal or metal alloy surface by removal of contaminants and deliberately applied protective compounds, conventional coil coating still requires pretreatment of the metal or metal alloy surface prior to painting. The term “pretreatment” denotes any chemical treatment of a metal or metal alloy coating surface for the purpose of promoting adhesion of paint to the metal or metal alloy surface. Pretreatment steps vary depending on the specific product received from the hot dip coating or electroplating facility and on the kind of pretreatment or conversion coating being applied. Pretreatment products can be highly acidic (pH 1-2) (Henkel Bonderite 1310 type products) or alkaline (Henkel Bonderite 1303). In most instances they contain heavy metals, including hexavalent chromium compounds, and are applied hot, from 100-160° F. (38-71° C.). After the pretreatment is applied, the sheet is water rinsed and a hot acidic (pH 3.5) hexavalent/trivalent chromium sealing rinse is applied to the strip. The pretreated and sealed strip receives a final rinse with water and is dried before it enters the organic coating section of the line. The mists and vapors from the pretreatment process typically are isolated from the work environment to avoid skin contact, eye contact, inhalation, or ingestion. The liquid waste stream from the pretreatment process contains heavy metals in solution and solid by-product precipitates. Such waste streams may pose environmental, health and safety risks and must be handled, treated, and disposed of properly.

The cleaning and pretreatment sections of conventional coil coater facilities require substantial capital investment, equipment, labor, line space, maintenance, chemicals, power, and provisions for the proper treatment and disposal of solid and liquid waste streams.

A number of new technologies have been developed in a continuing effort to reduce the environmental impact of coil coating operations. These new technologies include powder coating, solid block coating, ultraviolet (UV) radiation cured coatings, electron beam (EB) cured coatings, and laminates. As currently conceived, however, these new technologies still require the use of some combination of conventional passivating, oiling, cleaning, pretreating, and priming steps to prepare the hot-dip coated or electroplated sheet for finish coating. This dependence upon conventional coil coating process steps has been a significant barrier to extensive commercialization of these newer, more environmentally benign technologies.

For example, one such newer coil coating technology, Dried-in-Place (DIP) pretreatment, is sometimes substituted for the conventional conversion coating type pretreatment described above. Unlike conventional conversion coatings, DIP pretreatments are applied at room temperature using a roll coater or by spray/squeegee, are dried using convection, infrared (IR), or induction methods, and are actively cooled with a blower or chill rolls so that the strip is at an acceptable temperature for painting when it reaches the organic coating section. Since the water rinse step is eliminated, DIP pretreatment sections generate less liquid waste volume than conventional conversion coating sections. Nevertheless, most DIP pretreatments contain hexavalent and trivalent chromium and are acidic (pH 2) and some waste is produced during periodic cleaning and intentional purging of the roll coater and chemical delivery system. DIP pretreatment sections generally do not require as much line space as conventional conversion coating pretreatment sections, but this improved space efficiency is offset somewhat by increased capital and production costs associated with the application and drying equipment, ventilation or vapor capture and destruction systems, and chill rolls. Additionally, state of the art coil coating facilities incorporating DIP pretreatments fail to eliminate the need for applying passivates, oil coatings, and edge sealants in the hot dip coating or electroplating facility to protect the metal or metal alloy coated sheet product during storage and transport to the coil coating facility. The sheet also must still be cleaned as described above prior to application of the DIP pretreatment. Therefore, such state of the art coil coating facilities continue to produce substantial volumes of hazardous liquid and solid waste and the industrial hygiene issues associated with sheet cleaning processes are not remedied with DIP pretreatments.

Another example of advancement in coil coater technology is disclosed by Madigan in U.S. Pat. No. 6,004,629. Madigan teaches EB curing of a specifically formulated coating applied by a roll coater on an ultrasonically cleaned and pretreated strip. While this process eliminates the volatile organic compound (VOC) and hazardous air pollutant (HAP) emissions that are normally generated by finish coating processes, Madigan fails to teach further reducing the environmental impact of the process by eliminating wastewater discharge and VOC and HAP emissions from the cleaning and pretreatment sections. The patent discloses use of the pretreatment PPG “OrganoKrome 2000,” which contains both chromium compounds and 0.73 lb/gal (0.087 kg/L) of VOC. Furthermore, accelerated laboratory corrosion tests have shown that the resulting product exhibits significantly reduced corrosion resistance when compared to comparable hot dip coated sheet products manufactured with conventional coil coater applied pretreatments, prime coats, and finish coats.

Another newer method for continuously coating a metal strip, in an essentially solvent-free process, is disclosed by Buecher in U.S. Pat. No. 5,281,435. Buecher teaches coating a heated, moving metal strip by contact with a solid block of paint. The heat and pressure of the moving metal strip melt the solid paint block at the point of contact and liquid paint is deposited onto the moving strip. The liquefied paint layer is smoothed and doctored by rolling, and then is cured in a furnace and water quenched. The method teaches that the solid block coating is applied to a prime coated metal strip, but fails to teach a method for applying a prime coat to the metal strip before the solid block coating is applied. Although the Buecher process may reduce VOC during the finish coat process, there is no disclosure of eliminating conventional coil coater cleaning, pretreating, and prime coat application technologies.

Other examples of newer, nearly solvent-free final coat technologies used by or developed for coil coaters include powder coatings as disclosed by Escallon in U.S. Pat. No. 5,279,863, as well as laminates, and extrusion coatings applied with slot or die coaters.

All of these methods allow for substantial reduction of VOC from the finish coating process. It is still necessary, in each case, however, to clean, pretreat and prime coat the sheet in a manner similar to that described above for a conventional coil coating process in order to achieve proper coating adhesion, long term corrosion resistance, and durability in the fully painted steel product. The necessity to clean, pretreat, and prime coat the strip results in the continued generation of VOC, HAP, and liquid and solid waste streams from the coil coating processes.

Therefore, there is need within the art for development of more environmentally benign finish coating processes for metal or metal alloy coated continuous steel strip by eliminating inefficient intermediate coil coating steps that consume energy, waste heat, and generate liquid, solid, and airborne pollutants that adversely impact the workplace and global environments.

The finish coating facility embodied in the present invention eliminates the traditional intermediate treatment processes and environmental control systems. These finish-coating facilities may have line lengths of approximately 100 ft (30 m) and the total facility area may be reduced by a factor of 10. These facilities would reduce the required capital and operating costs relative to the present technology. These smaller, lower cost facilities can more efficiently service smaller customers or geographic areas and are capable of more efficiently processing small orders. Furthermore, these lower cost environmentally efficient facilities may be owned and operated by current prepainted sheet consumers.

### SUMMARY OF THE INVENTION

It is the object of the present invention to provide an environmentally benign, cost effective finish coating process that yields a finish coated steel sheet product that has equivalent or better performance than that produced by the prior art processes.

It is the object of the present invention to provide a finish coating process that applies near 100% solids coatings or waterborne compliant coatings to steel sheet products.

It is a further object of the present invention to provide a prime-coated (preprimed) continuous sheet product to the above mentioned finish coating process, thereby eliminating and reducing intermediate process steps, such as abrasive brushing, chemical cleaning and pretreatment steps and the associated health, safety and environmental risks and costs.

It is an object of the present invention to apply a primer coating on a continuous hot dip coating line or electroplating line, thereby eliminating the intermediate process steps of chemical passivation, oiling, edge sealing and the use of vapor phase corrosion inhibitors and the associated costs and environmental health and safety risks.

It is still another object of the present invention to reduce the space requirements for a coil coating operation.

It is still another object of the present invention to reduce capital costs, chemical consumption, power consumption, and environmental costs associated with the production of the finish coated steel sheet product.

Other objects and advantages of the present invention will become apparent as a description thereof proceeds. In satisfaction of the foregoing objectives, a finish coated steel sheet is formed by applying a finish coating onto preprimed metal alloy coated steel sheet. The preprimed metal steel sheet is produced by applying the primer coating to the metal alloy coated steel sheet surface immediately after depositing the metal alloy coating, while it is still in a pristine state.

These and other objects and advantages of the invention will be readily apparent in view of the following description and drawings of the above-described invention.

### BRIEF DESCRIPTION OF THE DRAWINGS

The above and other objects, advantages and novel features of the present invention will become apparent from the following detailed description of the preferred embodiments of the invention illustrated in the accompanying drawings, wherein:

FIG. 1 is a flow diagram showing a prior art hot-dip coating line and an electroplating line in a conventional steel mill operation.

FIG. 2 is a flow diagram showing a prior art conventional coil coating line operation.

FIG. 3 is a flow diagram showing the hot-dip coating line and the electroplating line of the present invention in use at a steel mill operation.

FIG. 3a is a flow diagram showing a 3-step process for applying the prime-coat of the present invention.

FIG. 3b is a flow diagram showing a 2-step process for applying the prime-coat of the present invention.

FIG. 3c is a flow diagram showing a 1-step process for applying the prime-coat of the present invention.

FIG. 3d is a flow diagram using a forced gas system to cool prime-coated steel sheet manufactured in accordance with the process of the present invention.

FIG. 3e is a flow diagram using a water mist system to cool prime-coated steel sheet manufactured in accordance with the process of the present invention.

FIG. 4 is a flow diagram showing a finish coat applied according to the present invention FIG. 4a shows using ultrasonic energy to clean prime-coated steel sheet manufactured in accordance with the process of the present invention.

FIG. 4b shows using a dry cleaning method to clean prime-coated steel sheet manufactured in accordance with the process of the present invention.

FIG. 4c shows using a second dry cleaning method to clean prime-coated steel sheet manufactured in accordance with the process of the present invention.

FIG. 4d shows using a surface modification method to improve paint wetting and adhesion in finish-coated steel sheet manufactured in accordance with the process of the present invention.

FIG. 4e shows applying a powder to provide a finish coat in accordance with the process of the present invention.

FIG. 4f shows using a solid paint block to provide a finish coat in accordance with the process of the present invention.

FIG. 4g shows using a hot melt paint process to provide a finish coat in accordance with the process of the present invention.

FIG. 4h shows applying a laminate film to provide a finish coat in accordance with the process of the present invention.

FIG. 4i shows applying a laminate film to provide a finish coat in accordance with the process of the present invention.

FIG. 5 is a flow diagram showing the present invention in use on a start-stop coil coating line operation.

### DETAILED DESCRIPTION OF THE PREFERRED EMBODIMENT

Prior Art

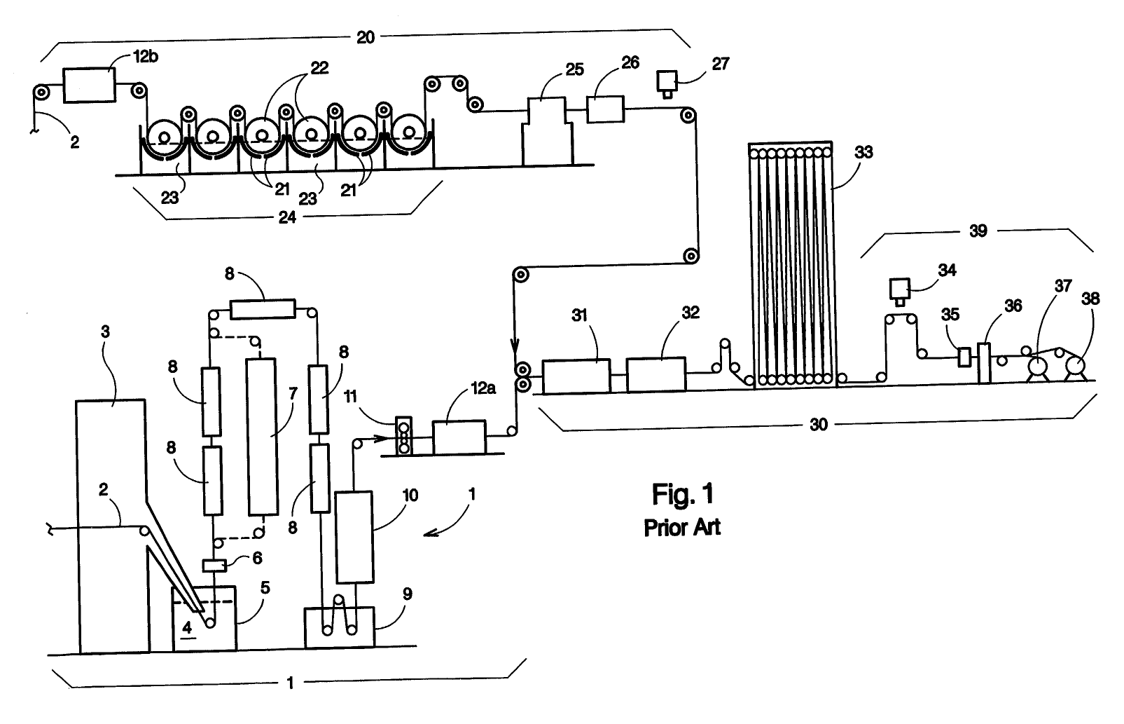

Referring to FIG. 1 illustrating a hot-dip coating line 1 and an electroplating line 20 combined into a single drawing labeled Prior Art, a conventional steel mill continuous coating line comprises various post coating processing steps that are typically used to produce a high quality paintable, corrosion-resistant metal-coated sheet product that will not degrade during storage and transport to end users or coil coating lines. For example, in a continuous high speed hot-dip coating line 1, a cleaned, and sometimes annealed, continuous steel sheet 2 is introduced at the entry end 3 of the line at a rate of up to 600 ft/min (183 m/min), and is immersed into a molten zinc, zinc alloy, aluminum, or aluminum alloy bath 4 contained within a hot-dip coating pot 5 where the steel sheet receives a hot-dip zinc, zinc alloy, aluminum, or aluminum alloy coating. FIG. 1 illustrates applying a hot-dip coating or electroplated coating to both sides of the steel sheet. It is well known in the art, however, to apply such a hot-dip coating or electroplate to only one side or surface of a continuous steel sheet. Therefore, it should be understood that in the following descriptions and embodiments of the present invention, either one or two sides of the steel sheet may receive a zinc, zinc alloy, aluminum, or aluminum alloy coating without departing from the scope of this invention.

After the hot-dip coated steel sheet exits the coating pot 5, excess molten metal coating is removed from the sheet surface by gas wiping as the continuous moving hot-dip coated steel sheet passes between air knife nozzles 6. In some instances, the hot-dip coated sheet enters a furnace 7 where the coating is reheated to a target temperature to promote inter-diffusion between the hot-dip coating and the steel substrate, for example, iron diffusion into zinc to yield a galvanneal coating. Whether the coated sheet is first reheated or not, the coated sheet enters a cooling tower 8, a quench tank 9, and a drier 10 to solidify, cool and dry the metal-coated steel sheet product. In some continuous hot-dip coating line operations, the sheet passes through a temper mill 11 for skin passing and/or a tension leveler 12a to produce a flat steel sheet with uniform hot-dip coating thickness of acceptable surface quality.

In a continuous electroplating line 20, for example an electrogalvanizing line, the cleaned continuous steel sheet 2 moves at high speed, up to 600 ft/min (183 m/min), through a series of separate plating cells comprising anodes 21 and cathodes 22 immersed in an electrolyte 23 contained in a series of multiple tank plating units. The last plating unit 24 in the series is shown in FIG. 1. In some electroplating operations, the continuous steel sheet 2 passes through a tension leveler 12b before it is immersed in the electrolyte bath 23 contained in the plating units including unit 24. After leaving the plating section, in instances where the desired metal-coated product is electrogalvanized, the sheet enters rinse tank 25 that removes any remaining electrolyte, a drier 26, and an inspection station where the metal-coated sheet steel product is monitored. The inspection station may comprise any suitable thickness measurement device, for example an x-ray gage 27 that continuously monitors coating thickness and provides a feedback signal to a computer for process adjustments. Although not shown in FIG. 1, conventional continuous hot dip coating lines typically also include an inspection station. The inspected electrogalvanized steel sheet product continues downstream for further processing similar to the downstream processing of hot-dip metal-coated steel sheet. A number of steel sheet products can be produced by processes similar to those described above, for example, electrogalvanized, zinc nickel, and zinc iron type electroplate coatings.

The downstream processing section 30 of a continuous high speed steel sheet coating line typically includes a chemical treatment station 31 for applying a chemical passivate solution to the metal-coated surface of the steel sheet 2. Such chemical solutions may be applied using an immersion tank, a spray and squeegee arrangement, or roll coater equipment. The chemically treated surface is dried using a hot air blower or other suitable drying device shown as 32. In instances where the metal coating is a hot-dip zinc or zinc alloy coating, for example as applied in the hot-dip coating line 1, the metal coating is chemically passivated. Typical passivates, such as Henkel Passerite 225 or Oakite OkemCoat F1 for hot-dip zinc and zinc alloy coatings are highly acidic (pH 1-2) and contain hexavalent chromium.

Subsequent to the chemical passivate and drying steps at 31 and 32, respectively, the strip enters an accumulator 33, an inspection station 34, and an oiler 35 where it is oiled with vanishing oil containing both volatile organic compounds and corrosion inhibitors, for example barium sulfonate or calcium sulfonate. Vanishing oils are usually applied with electrostatic oilers. After oiling, the sheet passes through a shear 36 that cuts the sheet steel product to a predetermined length after an appropriate amount of the sheet product is fed into a recoiler 37. The leading sheared end of the continuous running steel sheet is fed into a second recoiler 38 to wind a second coil of steel sheet product while the first coil of product is removed from recoiler 37 and packaged in paper or plastic wrapping that contains vapor phase corrosion inhibitors. Use of two recoilers 37 and 38 reduces the time that the strip in the exit section 39 is stationary and reduces the amount of steel sheet 2 that must be accumulated in the exit accumulator 33. In some instances, edge sealant is applied to the sides of the coil prior to packaging to minimize moisture intrusion between the laps of the metal or metal alloy coated steel coil.

In instances where the metal coating is an electroplated, electrogalvanized, or electroplated alloy coating, for example as applied in the electroplating line 20, the metal coating may be chemically passivated similar to a hot-dip coating treatment and/or it may receive an oil coating for improved corrosion resistance during transit and storage. Typical passivates for electroplated metal coatings and zinc alloy coatings are Henkel Passerite 225 or Oakite OkemCoat F1.

Chemical passivation, oiling, edge sealing and packaging with vapor phase corrosion inhibitors are all intended to stabilize the reactivity of the hot-dip coated or electroplated steel sheet surface and isolate it from the ambient environment and moisture. These steps minimize corrosion of the metal coating applied to the steel sheet surface during storage conditions and/or transport to an end user or a coil coating line for painting. Use of hexavalent chromium passivates in the continuous high speed coating line may present health and safety issues.

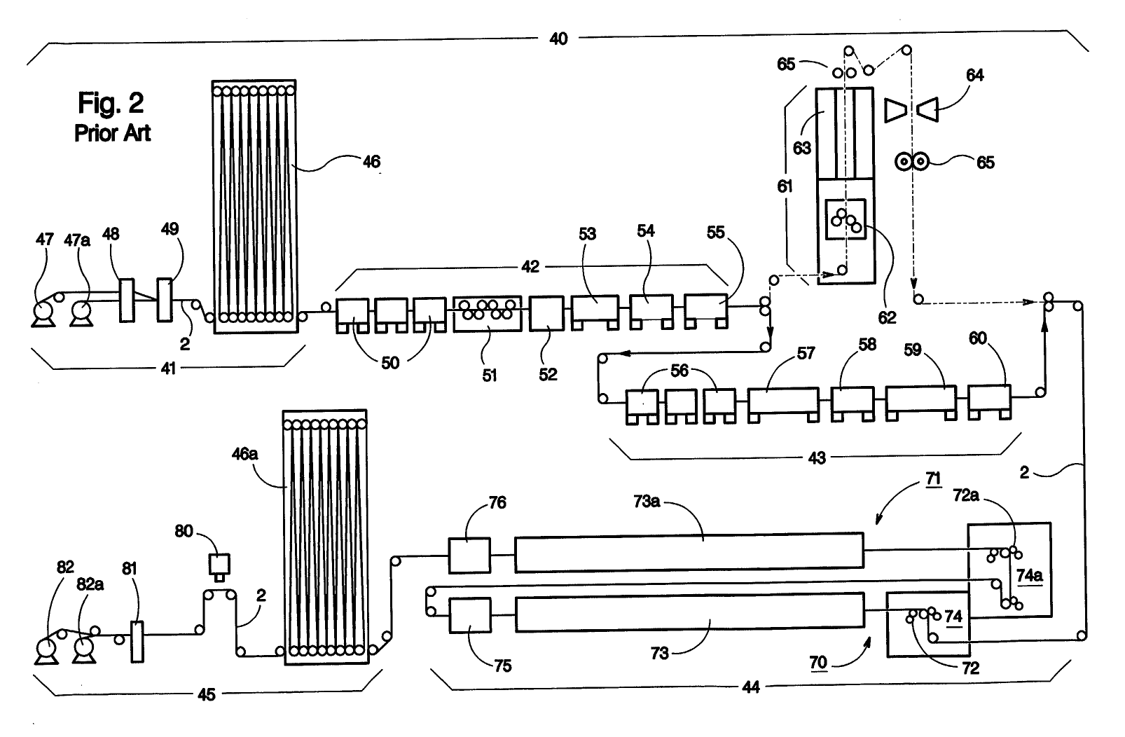

Because oils and passivates interfere with painting, steps must be taken at the coil coating line to remove such materials from the metal-coated surface before the steel sheet is painted. Referring to FIG. 2, labeled Prior Art, a conventional coil coating line 40 is shown having an entry end 41, followed by various processing sections, for example a cleaning section 42, a pretreatment section 43, a coating (painting) section 44, and an exit end 45. The entry and exit ends 41 and 45 include accumulators 46 and 46a, respectively, that arrange the sheet in a plurality of large loops that are adjusted in length over movable roll carriages to provide a constant sheet speed throughout the processing sections 42, 43 and 44 in response to line stops in the entry and exit ends 41 and 45. For example, when it becomes necessary to stop the steel sheet at the entry end 41 during a coil splicing operation, the roll carriages move together in a direction that will reduce the length of steel sheet loops in accumulator 46 while sheet continues to be fed, at a constant speed, into the processing sections 42, 43, and 44 located downstream from accumulator 46. The roll carriages also move in a direction away from each other to expand accumulator 46a and increase the length of its sheet loops in order to take up incoming strip from the constant speed portions of the line when a finished coil is being removed from one of the recoilers 82 or 82a in the exit end 45 of the line.

The entry end 41 of a conventional coil coating line 40, also called a paint line within the industry, consists of two uncoilers 47 and 47a, shears 48, a splicer 49 and the entry accumulator 46. This entry end arrangement allows for setting up a new coil of steel sheet on one uncoiler while the tail end of a finished steel sheet coil pays off a second uncoiler. The shears 48 and splicer 49 are used to cut and connect the leading end of the new coil to the tail end of the finished coil. This permits essentially an endless or continuous operation of the coil coating process.

As heretofore mentioned, the protective oils and passivates that are applied at a continuous hot-dip coating or electroplating line are removed before the metal-coated steel sheet is painted. This is done in the cleaning section 42 of the coil coating line 40. The cleaning section is the first constant speed portion along the coil coating line and includes multiple tanks 50 where hot aqueous alkaline solution is spray applied to the sheet. The metal-coated sheet is sometimes also abrasively brushed in a mechanical cleaning apparatus 51 to remove surface oxides and tenaciously adhered surface contaminants. The abrasive brushing produces a fresh metal surface that has improved reactivity so that it is more readily pretreated. After brushing, the steel sheet is rinsed at 52, chemically cleaned at 53, and receives a final water rinse at 54 and 55 immediately prior to entering the pretreatment section 43 of the line. A typical coil coating cleaning section may comprise some subset of these steps arranged in any order and may also include an electrolytic cleaning step and active drying of the water-rinsed strip prior to pretreatment.

Cleaning in section 42 involves alkaline chemicals, substantial quantities of water and power to drive the spray and recirculation pumps, to power the brushes, and to heat the cleaning and rinse solutions. The cleaning process is directed to removing tramp oils and contaminants, as well as compounds that are deliberately applied to the metal-coated surface in the steel mill, such as the vanishing oils, corrosion inhibitors, and soluble and insoluble chromium and zinc compounds from the passivation treatment. The abrasive brushing at 51 produces particulate waste containing the hot-dip or electroplated metals as well as the chromium passivation compounds.

The mists and vapors generated by the cleaning section 42 are removed from the work environment because of the hexavalent chromium contained in cleaning solutions that come into contact with the metal-coated sheet during cleaning at 42. The aqueous waste stream that is discharged from such cleaning operations has a high pH and contains oils, metal particles, and heavy metal ions in solution. The cleaner section waste stream may pose environmental, health and safety risks and should be handled, treated and disposed of properly. In addition, the cleaning section 42 requires substantial line space and capital and operating costs for equipment, chemicals, power and proper handling, treatment and disposal of the solid and liquid waste streams.

The pretreatment section 43 of a conventional coil coating line contains a number of tanks 56 to apply a conversion coating and a sealing rinse tank 58 to apply a sealing rinse to the cleaned metal-coated steel sheet 2. The pretreatment steps may vary depending on the specific metal surface being painted and on the composition of the conversion coating, sealing rinse and paint being applied. Pretreatment products can be highly acidic (pH 1-2), for example, Henkel Bonderite 1310 type products, and zinc phosphate treatments, such as Henkel Bonderite 1421. Pretreatment products can also be highly alkaline (pH 13-14), for example Henkel Bonderite 1303 type products. In most instances, such highly acidic or highly alkaline pretreatment products contain heavy metals including chromium, nickel and zinc, and are applied hot, from about 100-160° F. (37.8-71.1° C.). The pretreatment is applied to the steel sheet in tanks 56. After pretreatment at 56 and optional water rinsing at 57, the metal-coated steel sheet is seal rinsed at 58 where a hot acidic (pH about 3.5) hexavalent/trivalent chromium rinse, that may contain hydrogen fluoride, is applied to the sheet surface. The pretreated strip receives a final water rinse at 59, and a deionized water rinse at 60 before it enters the organic coating section 44 of the line.

The mists and vapors emitted from the pretreatment process along section 43 typically are isolated from the work environment to avoid skin contact, eye contact, inhalation and ingestion. Additionally, the liquid waste stream from the pretreatment process contains heavy metals in solution and solid by-product precipitates. The pretreatment waste stream may pose environmental, health and safety risks and should be handled, treated and disposed of properly. Finally, the pretreatment section also requires substantial line space and significant capital and operating costs are associated with the labor, equipment, chemicals, power and treatment and disposal of the solid and liquid waste streams.

An alternative to the pretreatment process described for section 43 is a less used “Dried-in-Place” (DIP) pretreatment shown as section 61 in FIG. 2. Similar to conversion coatings, DIP pretreatments are applied to the metal-coated steel sheet immediately after cleaning. Unlike conversion coatings, however, DIP pretreatments are applied at room temperature using a roll coater 62, or by spray/squeegee (not shown). DIP pretreatments, such as Henkel Bonderite 1402W, contain hexavalent and trivalent chromium and are acidic (pH 2). The pretreatment is dried using a convection, infrared, or induction furnace 63 followed by active cooling with a blower 64 and/or chill rolls 65 to reduce the temperature of the dried strip before it enters the organic coating section 44. Because the water rinse step is eliminated in a DIP process, such pretreatment sections generate less liquid waste than conventional pretreatment sections that apply conversion coatings as described for section 43. Nevertheless, some waste is produced during periodic cleaning and intentional purging of the roll coater 62 and the chemical delivery system (not shown). If an infrared or induction drying furnace 63 is used in combination with chill rolls 65, DIP pretreatment requires less line space than a conventional conversion coating section as shown in section 43. The improved space efficiency is somewhat offset, however, by increased capital and operating costs associated with the roll coater mechanism 62, drying oven 63, ventilation or vapor capture systems (not shown), and chill rolls 65.

A significant amount of research and development has been aimed at eliminating hexavalent chromium from both conventional and DIP pretreatment formulations. Very few such products have been commercialized as a result of this effort, however, and significant environmental, process, and performance issues remain unresolved.

After the metal-coated steel sheet is cleaned and pretreated with either a conversion or DIP coating, the pretreated strip enters the prime coat and finish coat portions, 70 and 71 respectively, of the organic coating section 44 of the coil coating line shown in FIG. 2. The prime coat and finish coats or topcoats are applied using reverse roll coaters 72 and 72a and are typically cured using catenary type convection ovens 73 and 73a. It should be understood, however, that induction and infrared curing ovens are also utilized for curing organic coatings. Nevertheless, convection ovens remain the apparatus of choice because the heat energy contained in the volatile organic compounds (VOC) of the paint can be released upon combustion to improve convection oven energy efficiency.

The cleaned and pretreated continuous metal-coated sheet steel enters the primer booth 74 where an organic prime coat is applied to the metal-coated surface of the steel sheet 2 with the reverse roll coaters 72. Such organic prime coats contain inorganic pigments that provide color, texture, and corrosion resistance. The prime-coated surface is dried and cured in the primer oven 73 and water quenched at 75 before entering the finish or topcoat booth 74a. The organic topcoat is applied to the cured prime coat using a second set of roll coaters 72a. The topcoat is dried and cured in the topcoat oven 73a and water quenched at 76 before it enters the exit section 45 of the coil coating line 40. Most primers for use in exterior applications contain hexavalent chromium corrosion inhibitors, such as strontium chromate and zinc dichromate. These chromium compounds are soluble in water and can be leached out of the primer by the quench water. Primer quench water is therefore treated and discharged with the liquid waste stream from the cleaning and pretreatment section. The VOC and HAP emitted from the primer and topcoat typically require paint lines to have expensive capture and control equipment.

Solvent borne primers are the most widely used primers for the metal building products industry. Solvent-based coatings contain from 30-70% by volume VOC. It is estimated that approximately 85% of the coatings used for metal coil are organic solvent based, with the rest being waterborne formulations (Ref.—Preliminary Industry Characterization Metal Coil Surface Coating Industry, U.S. EPA, Office of Air Quality Planning and Standards, Sep. 30, 1998). Waterborne coatings have VOC contents of about 2 to 15% by volume. Coatings used in the coil coating industry may contain 5 to 28% by weight toxic or hazardous air pollutants (HAP) that are suspected to cause serious health problems. The metal coil coating industry is estimated to be emitting about 2,590 tons per year of HAP (Ronald Pietrzak, Executive Director of National Coil Coaters Association to U.S. EPA, Jun. 7, 2000).

After painting, the strip enters the exit accumulator 46a and moves through an inspection station 80, an exit shear 81, and is recoiled for wrapping, storage, and shipping in alternate recoilers 82 and 82a. As heretofore described, the exit accumulator 46a allows for continuous operation of the cleaning, pretreatment and coating sections 42, 43, and 44 while the strip is being recoiled, sheared and removed from the recoilers 82 and 82a.

It may be observed from the foregoing that conventional coil coating systems involve a substantial expenditure of time, labor, capital, and operating costs by the steel mill to prepare the metal-coated sheet so that it may be shipped to the coil coating operation in a manner in which the steel sheet is not readily suitable for finish coating. Additionally, substantial expenditures of time, labor, capital, and operating costs are incurred at the coil coating facility to remove and/or undo what was done during the postcoating operations at the steel mill. Collectively, the steel mill and the coil coating facility incur substantial costs, and thus increase the cost of the finished product, merely to facilitate shipment, storage, and handling of the metal coated sheet. These added costs do not increase the value of the finished product or enhance its usability.

### DETAILED DESCRIPTION OF THE INVENTION

Prime Coat

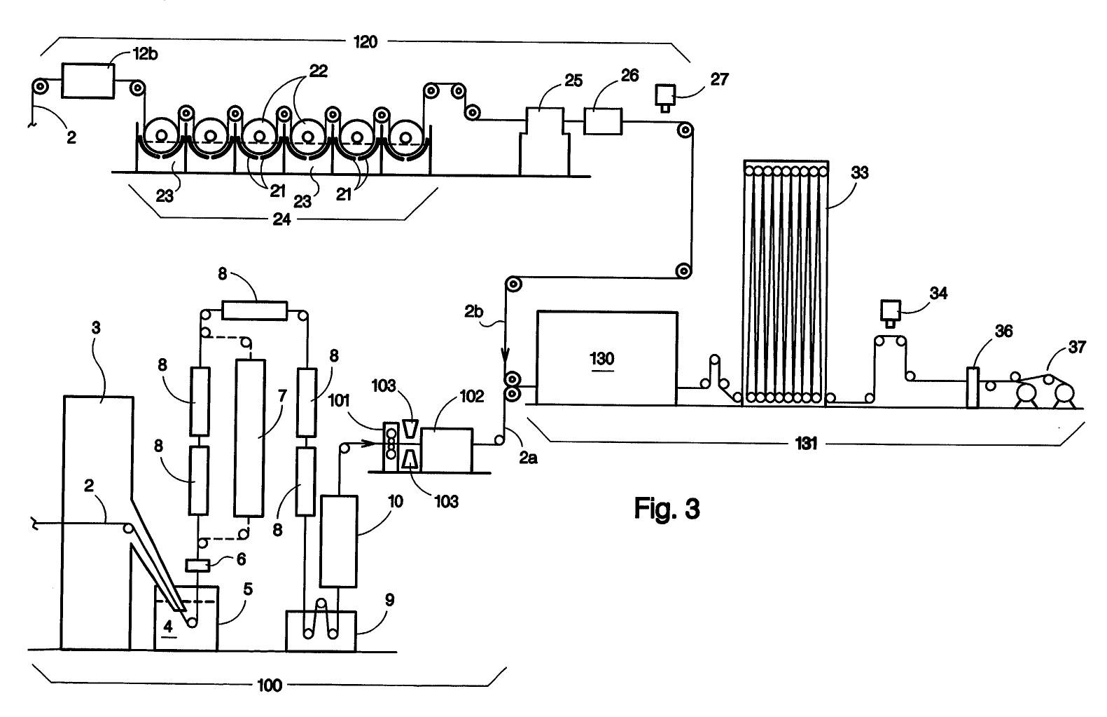

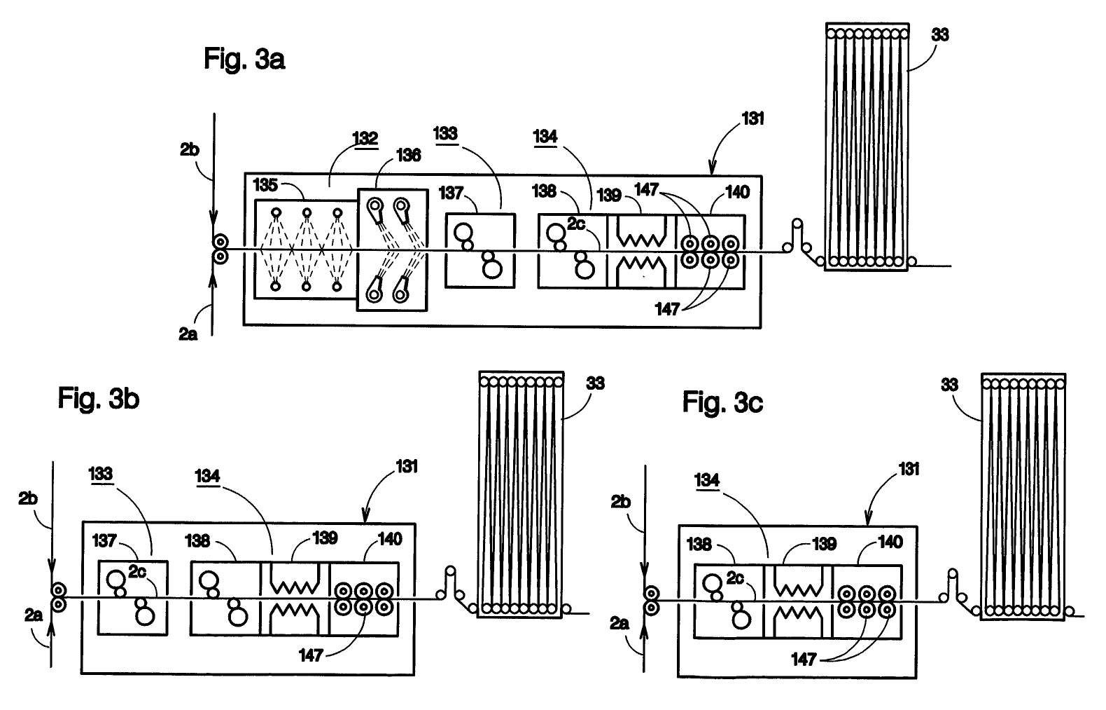

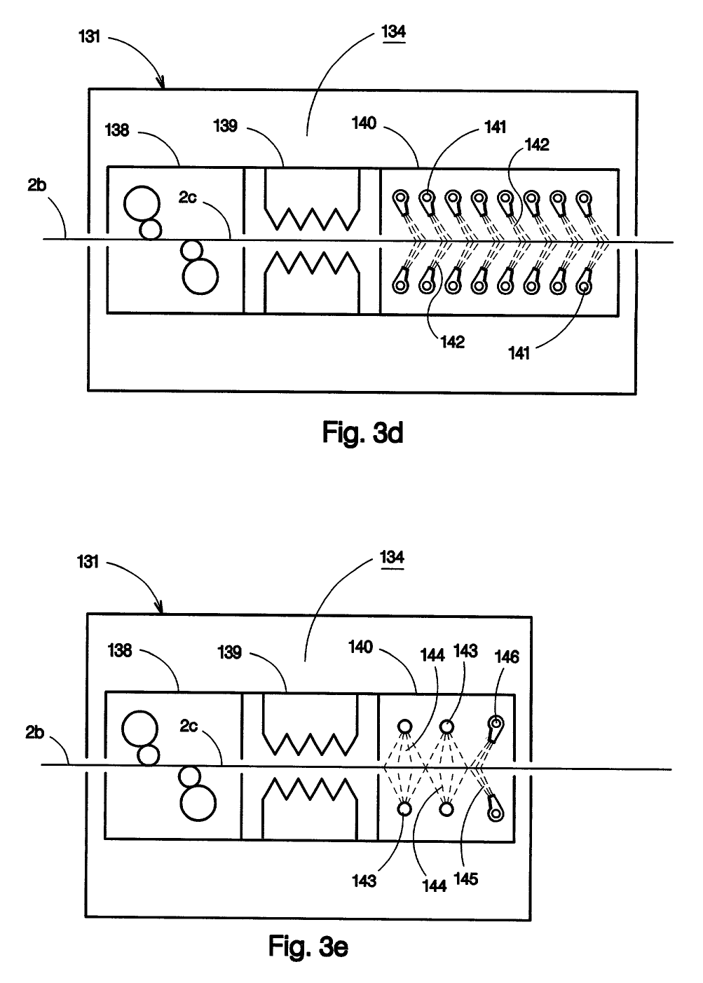

Referring to FIG. 3, the drawing figure illustrates both a hot-dip coating line 100 and an electroplating line 120 combined into a single drawing figure that includes a primer application section 131 that is capable of receiving metal-coated product 2a from the hot-dip coating line 100 or metal-coated product 2b from the electroplating line 120. The combined hot-dip coating/electroplating figure illustrates that primer section 131 is suited for use in either a hot-dip coating or an electroplating line operation. The primer application process 130 reduces environmental impact and the capital and operating costs from conventional coating line operations by applying a prime coat directly to the metal-coated surface of the sheet steel product in the absence of chemical passivate materials, oils, or corrosion inhibitors that are applied to the continuous steel sheet in a conventional hot-dip or electroplate coating line as described for FIG. 1.

Referring again to FIG. 3, products that are produced in such continuous hot-dip coating lines 100 include steel sheets coated with aluminum, zinc, aluminum alloy and zinc alloy coatings, such as hot-dip galvanized, galvanneal, Galvalume®, Galfan and aluminized steel sheet products. The hot-dip coated steel sheet 2a may be temper rolled (skin passed) in a mill 101 to improve its surface and mechanical properties, and tension leveled at 102 to improve the strip shape before it moves downstream to the continuous coil coating section 131 where it receives a prime coat. Temper rolling may be accomplished dry, with water, or with water- or oil-based rolling solutions. Small amounts of water used in temper rolling can be flash dried from the sheet during the rolling process, or actively removed by blowers or hot air dryers 103 after temper rolling 101. Similarly, the electroplated products that are produced in the continuous electroplate line 120 include electrogalvanized, zinc nickel, or zinc iron electroplated metal coatings that are applied to the continuous steel sheet 2. After the continuous steel sheet is electroplated 2b, it moves downstream to the continuous coil coating section 131 for processing similar to the hot-dip metal-coated product 2a.

In accordance with the preferred embodiment of the present invention, the metal-coated sheet steel substrate 2a or 2b passes through a coil coating station 130 located downstream from the hot-dip coating section of the line 100 or downstream from the electroplating section of the line 120. In instances where a prime coat is applied to a freshly hot-dip coated product 2a, the coil coating station 130 may be positioned either upstream or downstream from the temper mill 101 and the tension leveler 102, if such apparatus is included in the continuous hot-dip coating line. The prime coat may be applied to the pristine metal-coated surface immediately after it exits the hot-dip coating or electroplating lines 100 or 120 using any one of the methods described below. As used herein, pristine metal-coated surface means a coating surface on the strip immediately after the strip exits the hot-dip coating line 100 or the electroplating line 120.

Comparing the prior art of FIG. 1 with the present invention shown in FIG. 3, application of a prime coat in accordance with the steps of the present invention eliminates environmental, health and safety issues, and eliminates the chemical passivation process associated with coating lines similar to FIG. 1. For example, applying a prime coat directly to the pristine metal-coated steel sheet surface 2a or 2b enables operators to eliminate the chemical passivation and drying steps 31 and 32 shown in FIG. 1. Application of a prime coat, in the absence of chemical passivate, eliminates the environmental, health and safety issues and costs associated with chemical passivate operations. In addition, applying a prime coat at the hot-dip coating or electroplating line operation eliminates any need for applying vanishing oils, edge sealants and vapor phase corrosion inhibitors. The elimination of such materials reduces environmental, health and safety issues associated with removing such protective materials from the product surface before paints are applied at the coil coating line as herein described for the prior art paint line shown in FIG. 2.

As best shown in FIG. 3a, the coil coating section 131 comprises a three-step prime coat process that includes: a cleaning station 132 where the metal-coated product is cleaned at 135 and dried at 136; a pretreatment station 133 including an apparatus 137 to apply a pretreatment material to the metal-coated surface to promote paint adhesion and an apparatus to dry 137a and cool 137b the pretreated metal-coated sheet; and a paint station 134 including an apparatus 138, such as a roll coater, to apply a prime coat to the product surface, an apparatus 139, such as an oven, to dry and cure the prime coat, and an apparatus 140, such as chilled rolls, to cool the cured prime coat.

Cleaning at station 132 may be accomplished by spraying the metal-coated surface with hot water at 135 and then drying at 136. If more aggressive cleaning is required to remove temper rolling solution, then alkaline or detergent solutions are sprayed onto the metal-coated surface at 135 followed by hot water spray rinsing prior to drying at 136. Exemplary cleaning material that may be applied at cleaning station 135 is Henkel Parco 338.

The pretreatment section 133 may have either a horizontal or vertical configuration. The pretreatment chemicals may be applied either by forward or reverse roll coater or spray/squeegee devices. Exemplary pretreatment materials that may be applied at pretreatment station 133 include chromate-containing and chromium-free DIP pretreatments (such as Henkel Bonderite 1402 Oakite OkemCoat F2 and Bonderite 1455). The pretreatment drying at 137a is accomplished by convection, induction, and/or infrared methods. The strip may be cooled at 137b prior to entry into the coater 138 using an air blower to convectively cool the metal-coated steel sheet and/or by using chilled rolls to conductively cool the metal coated steel sheet by contact.

Exemplary primers that may be applied at paint station 134 include solvent borne and waterborne primers such as Valspar PMY0154 and Lilly 623-L-133, respectively. The primers may be applied using any suitable roll coating application means. Additionally, the prime coat may be dried and/or cured in a convection, induction, or infrared furnace at 139. After exiting the drying and curing furnace 139 the strip is cooled by any combination of quenching, water mist, air blowers and/or chilled rolls 147 at 140 before it enters the exit end accumulator 33 for inspection 34, recoiling 37 and shearing to length 36 (FIG. 3).

When a prime-coated product is produced at the steel mill coating line, the prior art oiling step 35 and the chemical treatment 31 and drying device 32 (FIG. 1) are not included in the prime coat process line 131. The three-step prime coat may be applied at any suitable location along a hot-dip coating line after the metal coating has solidified and cooled on the steel sheet surface. In instances where the product is electroplated, the three-step prime coat is applied downstream from the inspection station 27.

Because the incoming sheet is pristine, without applied oils and passivates, the spent water from cleaning station 132 contains only minute contaminant levels and requires little or no treatment prior to discharge. Such rinse waters may be recycled in a closed loop system (not shown). This provides a substantial reduction in waste generation over current methods that clean and abrasively brush chromate passivated and oiled hot-dip coated sheet products prior to painting at a prior art coil coating line as shown in FIG. 2. If a chromate-containing DIP pretreatment and a solvent borne primer are used in the three-step prime coat process shown in FIG. 3a, the process generates potential environmental, health, and safety risks analogous to current coil coating lines using such products. The present invention allows elimination of the cleaning, pretreatment and primer steps from current coil coating operations, however, and significantly reduces the number of point sources associated with these current processes. It also allows concentration of the environmental liabilities in only a few facilities. The resulting efficiencies of scale permit a more cost effective application of the most advanced environmental control technologies. Furthermore, the waste streams and waste materials handling issues associated with passivate and vanishing oil application and removal are eliminated. In addition, if a chromium-free dried-in-place pretreatment is used, the environmental, health, and safety risks are reduced further. Finally, if a VOC compliant waterborne primer is used in combination with chromium free pretreatment, the environmental, health, and safety risks are reduced even further, and cost savings are realized through the elimination of the need for VOC control equipment.

The embodiment of FIG. 3b illustrates the coil coating section 131 as comprising a two-step prime coat process at a steel mill hot-dip line or electroplate line. The process includes the pretreatment station 133 where apparatus 137 applies a pretreatment material to the metal-coated surface to promote paint adhesion, and a painting station 134 where apparatus 138 applies a prime coat to the product surface using any of the above mentioned suitable application apparatus. The two-step prime coat process further reduces environmental impact by eliminating minute contaminant levels associated with the cleaning station 132 taught in the three-step prime coat process of FIG. 3a. The pretreatment materials used in the two-step process shown in FIG. 3b are similar to the pretreatment materials used in the three-step prime coat process illustrated in FIG. 3a. The pretreatment is dried at 137a and the sheet is cooled at 137b in the same manner described for FIG. 3a. The prime coat is applied by a roll coater at 138 to the surface of the metal-coated steel sheet and is dried and/or cured in a convection, induction, or infrared furnace 139 in a manner similar to that described for the three-step prime coat process shown in FIG. 3a. After exiting the drying and curing furnace the strip is cooled by any combination of quenching, water mist, air blowers and/or chilled rolls 147 at 140 before it enters the exit end accumulator 33 for downstream processing as described above.

As best shown in FIG. 3c, the coil coating section 131 comprises a one-step prime coat process. This embodiment maximizes the utility and value of the invention by eliminating the pretreatment sections and their resultant costs and liabilities. The prime coat is applied directly to the pristine metal-coated steel sheet surface at station 134 absent any cleaning or pretreatment steps. One exemplary process for applying a one-step prime coat directly to the pristine metal-coated surface is continuous thermal coating deposition of waterborne primers as taught in Friedersdorf, et al. U.S. patent application Ser. No. 09/517,064, the assignee of which is also the assignee hereof and the disclosure of which is incorporated herein in its entirety by reference. Test results show that such thermal deposition coatings have as best shown in Tables 1 and 2.

TABLE 1
T-bend adhesion tests results for fully painted Galvalume coated metal
sheet primed with either Q-coat or conventional primers (ASTM D4145-83).
Each bend rated for adhesion by tape pull and degree of cracking.

| | 0T | | 1T | | 2T | | 3T | 4T | 5T | 6T | 7T | T-no | |
|---|---|---|---|---|---|---|---|---|---|---|---|---|---|
| Primer | crk* | tape† | crk | tape | crk | crk | crk | crk | crk | crk | crk | crk | T-no tape |
| Q-coat Acrylic-A | 4 | 8 | 6 | 9 | 8 | 10 | 9+ | 10 | — | — | — | 4 | 2 |
| | 4 | 8 | 8 | 10 | 9 | — | 9+ | 10 | — | — | — | 4 | 1 |
| | 4 | 9 | 8 | 10 | 9 | — | 9+ | 10 | — | — | — | 4 | 1 |
| Q-coat Acrylic-B | 4 | 8 | 8 | 9 | 10 | 10 | — | — | — | — | — | 2 | 2 |
| | 4 | 9 | 6 | 9+ | 9+ | 10 | 9+ | 10 | — | — | — | 4 | 2 |
| | 4 | 9 | 6 | 9+ | 9+ | 10 | 9+ | 10 | — | — | — | 4 | 2 |
| Q-coat Epoxy | 4 | 10 | 6 | — | 9 | — | 10 | — | — | — | — | 3 | 0 |
| | 4 | 10 | 6 | — | 9+ | — | 10 | — | — | — | — | 3 | 0 |
| | 4 | 10 | 6 | — | 9 | — | 10 | — | — | — | — | 3 | 0 |
| Q-coat Epoxy | 4 | 9+ | 6 | 10 | 8 | — | 8 | 8 | 9 | 9 | 10 | 7 | 1 |
| Conventional | 4 | 9+ | 6 | 10 | 8 | — | 10 | — | — | — | — | 3 | 1 |
| Polyester | 4 | 10 | 6 | — | 8 | — | 9 | 10 | — | — | — | 4 | 0 |
| | 4 | 10 | 6 | — | 8 | — | 10 | — | — | — | — | 3 | 0 |
| Conventional | 4 | 9 | 4 | 10 | 8 | — | 8 | 9 | 9+ | 10 | — | 6 | 1 |
| Acrylic | 4 | 8 | 4 | 9+ | 6 | 10 | 8 | 9 | 10 | — | — | 5 | 2 |
| | 4 | 9 | 4 | 9+ | 6 | 10 | 8 | 8 | 9 | 9+ | 10 | 7 | 2 |
| Conventional | 4 | 10 | 4 | — | 6 | — | 8 | 9 | 9 | 9+ | 10 | 7 | 0 |
| Waterborne | 4 | 9+ | 6 | 10 | 8 | — | 9 | 9+ | 10 | — | — | 5 | 1 |
| | 4 | 9+ | 4 | 9+ | 8 | 10 | 8 | 9 | 9+ | 10 | — | 6 | 2 |

*Crack rating: 10—No Crack,
†Tape off Rating: 10—No Tape Off

TABLE 2
Gardner reverse impact and cross hatch adhesion test results
for fully painted Galvalume coated metal sheet primed with
either Q-coat or conventional primers. Each impact dimple
rated for adhesion by tape pull and degree of cracking.
ASTM D2794-93 and ASTM D3359a-95 Method B.

| | 80 in-lb | | 100 in-lb | | 120 in-lb | | |
|---|---|---|---|---|---|---|---|
| Primer | Crack* | Tape* | Crack | Tape | Crack | Tape | X-hatch |
| Q-coat | 9+ | 10 | 9 | 10 | 8 | 10 | 5B |
| Acrylic-A | 9+ | 10 | 9 | 10 | 9 | 10 | 5B |
| Q-coat | 9+ | 10 | 9 | 10 | 9 | 10 | 5B |
| Acrylic-B | 9 | 10 | 9 | 10 | 8 | 10 | 5B |
| Q-coat | 10 | 10 | 10 | 10 | 8 | 10 | 5B |
| Epoxy | 9+ | 10 | 10 | 10 | 9+ | 10 | 5B |
| Q-coat | 8 | 10 | 8 | 10 | 6 | 10 | 5B |
| Epoxy | | | | | | | |
| Conventional | 10 | 10 | 10 | 10 | 9 | 10 | 5B |
| Polyester | 10 | 10 | 10 | 10 | 9 | 10 | 5B |
| | 9+ | 10 | 9+ | 10 | 9 | 10 | 5B |
| Conventional | 9+ | 10 | 8 | 10 | 6 | 10 | 5B |
| Acrylic | 9 | 10 | 8 | 10 | 6 | 10 | 5B |
| | 9 | 10 | 8 | 10 | 6 | 10 | 5B |
| Conventional | 9 | 10 | 9 | 10 | 8 | 10 | 5B |
| Waterborne | 9+ | 10 | 9 | 10 | 8 | 10 | 5B |
| | 10 | 10 | 9 | 10 | 8 | 10 | 5B |

*Cracking and tape-off rating 0-10, with 10 being no crack or tape-off, respectively.

Additionally, as best shown in Table 3, such coatings have good moisture resistance.

TABLE 3
Condensing humidity test results for fully
painted Galvalume coated metal sheet primed with either
Q-coat or conventional primers. Tests were performed at
140° F. for 1000 hours. (ASTM D4585-87, ASTM
D3359-95 Method B, ASTM D714-87).

| | X-Hatch | Overall Blister | |
|---|---|---|---|
| Primer | Tape Pull | Size | Density |
| Q-coat Acrylic-A | 5B | <#8,#8 | few |
| | 4B | #8 | few |
| | 5B | <#8, #8 | few |
| Q-coat Acrylic-B | 5B | #6, #8 | few |
| | 5B | #6, #8 | few |
| | 4B | #8 | few |
| Q-coat Epoxy | 5B | #8 | <few |
| Conventional | 5B | <#8 | few |
| Polyester | 5B | <#8 | <few |
| | 5B | none | |
| Conventional | 5B | <#8 | few |
| Acrylic | 5B | #8 | <few |
| | 5B | <#8 | <few |
| Conventional | 5B | <#8 | few |
| Waterborne | 5B | #8 | <few |
| | 5B | #8 | <few |

The thermal deposition coating also provide good corrosion protection, as best shown in Table 4, when applied directly to hot-dip Galvalume coated steel sheet that has not been passivated, oiled, cleaned or pretreated.

TABLE 4
Salt spray test results for fully painted Galvalume
coated metal sheet primed with either Q-coat or conventional
primers. Test duration was 750 hours. (ASTM B117-94)

| | Scribe Creep (mm) | | Edge Creep (mm) | |
|---|---|---|---|---|
| Primer | Max. | Avg. | Max. | Avg. |
| Q-Coat Acrylic-A | 0.0 | 0.0 | 3.8 | 1.0 |
| | 0.0 | 0.0 | 2.9 | 1.6 |
| | 0.0 | 0.0 | 4.1 | 1.5 |
| Q-Coat Acrylic-B | 0.0 | 0.0 | 5.0 | 1.9 |
| | 0.0 | 0.0 | 4.4 | 0.7 |
| | 0.0 | 0.0 | 4.0 | 0.9 |
| Q-Coat Epoxy | 0.6 | 0.1 | 3.6 | 1.5 |
| | 0.0 | 0.0 | 3.6 | 1.6 |
| | 1.0 | 0.1 | 4.5 | 2.1 |
| Q-Coat Epoxy | 0.7 | 0.2 | 3.2 | 0.7 |
| Conventional Polyester | 0.0 | 0.0 | 4.9 | 1.5 |
| | 0.0 | 0.0 | 3.6 | 1.3 |
| | 0.0 | 0.0 | 3.7 | 1.6 |
| Conventional Acrylic | 0.0 | 0.0 | 3.2 | 0.9 |
| | 0.0 | 0.0 | 3.8 | 1.2 |
| | 0.0 | 0.0 | 3.8 | 1.2 |
| Conventional | 0.0 | 0.0 | 7.3 | 4.1 |
| Waterbome | 2.2 | 0.3 | 9.5 | 4.5 |
| | 0.0 | 0.0 | 4.8 | 2.3 |

Thermal deposition coatings include waterborne acrylic, polyester, or epoxy ester formulations. Examples of such coatings are the Q-coat family of products available from Technical Coatings Company. The acrylic Q-coat formulation has a VOC content of less than 0.6 lb/gallon of coating solid and no HAP compounds. This is an extremely low VOC coating—lower than the pretreatment cited by Madigan in U.S. Pat. No. 6,004,629. Process gases from coating applications utilizing this coating formulation may be discharged directly to atmosphere in compliance with most state and federal environmental regulations. The hot-dip coated sheet may receive an optional hot water rinse or cleaning 135 and drying 136 as shown at 132 in FIG. 3a before the prime coat is applied. One-step prime coat processes provide substantial environmental, health, safety and cost benefits over existing conventional methods because they eliminate passivation, oiling, and pretreatment steps in addition to eliminating or minimizing the cleaning step. As in the previous examples, such environmentally compliant processes provide cost benefits associated with the elimination of a need for VOC capture and control equipment, as well as the elimination of waste treatment and disposal equipment. Furthermore, the present invention allows for the elimination of the cleaning, pretreating and priming steps from current coil coating operations and would significantly reduce the number of point waste sources associated with these current processes. Production and capital cost savings are also realized when compared with the prior art examples because a high maintenance roll coating apparatus is replaced with a low maintenance thermal coater.

A second exemplary system for performing a one-step prime coat process of FIG. 3c includes roll coater application of a solvent borne or a waterborne prime coat material onto the metal-coated surface of the steel sheet. One such roll coat primer material is the waterborne acrylic 1PMY43264 manufactured by PPG. Such roll-coated products are applied directly to the surface of the hot-dip coated steel in the absence of any pretreatment steps. Laboratory test results (see Table 5) show that PPG 1PMY43264 provides excellent paint adhesion and corrosion resistance when applied directly to hot-dip Galvalume coated steel sheet that has not been passivated, oiled, cleaned or pretreated.

TABLE 5
Results of T-bend adhesion (ASTM D4145-83), Gardner reverse impact (ASTM D2794-93), condensing
humidity (ASTM D4585-87) and salt spray (ASTM B117-94) for fully painted Galvalume. The
primers tested are PPG direct to metal primer PMY43264 and PPG conventional polyester primer
PLY5440. Some panels were caustic cleaned after priming prior to finish coating. All panels
were tested in the fully painted condition with primer and topcoat.

| | | | | | | | Salt Spray, 1000 hour | | | |
|---|---|---|---|---|---|---|---|---|---|---|
| | | | T-bend | | | Condensing | Scribe | | Edge | |
| | Cure | | T-no | T-no | Impact | Humidity | Creep (mm) | | Creep (mm) | |
| Primer | Temp C. | cleaning | crk | tape | 120 in-lb | blisters | max | avg | max | avg. |
| | 420 | none | 3 | 0 | pass | <few, <#8 | 2.5 | 0.3 | 6.7 | 3.2 |
| | 420 | none | 3 | 0 | pass | <few, <#8 | 2.5 | 0.3 | 6.7 | 3.2 |
| | 280 | none | 3 | 0 | pass | none | 2.0 | 0.2 | 6.0 | 4.8 |
| | 250 | caustic | 3 | 0 | pass | none | 0.8 | 0.2 | 4.8 | 3.6 |
| | 180 | caustic | 3 | 0 | pass | dense #4 | 0.6 | 0.2 | 4.5 | 2.6 |
| PLY5440 | 420 | none | 3 | 0 | pass | <few, <#8 | 3.3 | 0.6 | 5.6 | 2.8 |

As before, the hot-dip coated sheet may receive the optional hot water rinse or cleaning 135 and the drying 136 of FIG. 3a before the prime coat is applied to the Galvalume coating. In this instance, however, the Galvalume coating does not receive a chemical pretreatment. Such one-step prime coat processes provide substantial environmental, health, safety, and cost benefits over existing technology because they eliminate passivation, oiling, abrasive brushing and pretreatment steps as well as eliminate or minimize the cleaning steps. In instances where a VOC compliant waterborne primer is used, additional environmental, health, safety, and cost benefits are realized as mentioned in the previous examples. Furthermore, the present invention allows for the elimination of the cleaning, pretreatment and primer steps from current coil coating operations and significantly reduces the number of point waste sources associated with these current processes.

In each of the above one, two, and three-step prime coat process embodiments of FIGS. 3a, 3b, and 3c, the prime coat is dried and/or cured after it is applied to the pristine metal-coated steel sheet, and the dried/cured prime coat is cooled before it is recoiled. Referring collectively to FIGS. 3a-3d, and as heretofore mentioned, the prime-coated steel sheet 2c enters a drying and curing apparatus 139 where it is heated using suitable heat generating apparatus, such as a convection, induction, or infrared type furnace. One suitable method for drying and/or curing prime-coated steel sheet 2c elevates the steel sheet temperature using convection furnace technologies that are well known in the art. Convection furnaces improve drying and curing efficiency because of heat gain realized from the incineration of VOC emitted from the solvent borne coatings applied to the steel sheet surface. In a continuous high speed coating line, for example running at a line speed of about 300 to 600 feet/min. (91.4 to 182.9 meters/min.), convection curing requires substantial lengths of line space in order to properly dry and cure the fast running sheet product. Therefore, convection furnaces are not generally suited for retrofit into an existing steel mill coating line. In instances where a new coating line is being erected, however, the new hot-dip coating or electroplating line may be designed specifically to include the longer length convection type drying and curing furnaces.

A different exemplary method for drying and curing a prime coat applied in a steel mill coating line comprises induction curing at 139. Various systems and apparatus are available today for induction curing of paint films. For example, suitable induction curing apparatus are manufactured by Inductoheat, Ajax Magnethermic, EA Technology Limited, and Stein Heurtey. Induction heating quickly raises the steel sheet temperature to a target curing temperature, and such rapid heating minimizes the line length requirements for an induction apparatus. Therefore, induction heat apparatus is suitable for retrofit in an existing hot-dip coating or electroplating line.

Another exemplary method for drying and curing a prime coat applied to steel sheet in a steel mill coating line comprises infrared (IR) radiation curing at 139. A number of variants exist for IR curing of paint films, and the different IR curing units can be specified and supplied by companies such as ITW BGK. Infrared technology provides rapid heating of the prime-coated surface. It dries/cures the prime-coated surface faster than convection technology, but slower than induction technology. Similar to induction drying and curing, IR heating minimizes line space requirements and makes modification of existing hot-dip coating and electroplating lines more feasible. Additionally, power consumption is lower for IR furnaces than for induction furnaces. The heating rate is slower, however, as mentioned above.

Energy costs can be optimized and line length requirements can be reduced by using IR technology in combination with induction technology. Such IR/induction heating systems dry and cure paint by inductively heating the conductive steel substrate while the IR radiation applies heat directly to the paint or prime coat layer. In some instances, the most energy efficient system (that can be fit into an existing hot-dip coating line for curing a particular prime coat) is induction heating followed by infrared heating. Retrofit of a more efficient process into existing lines is accomplished by fast heating using induction to minimize line length requirements, followed by efficient IR heating of the paint film to complete the drying and curing. For example, suitable IR/induction curing apparatus are supplied by EA Technology Limited.

The dried and cured prime-coated sheet steel product exits the heating apparatus 139 at an elevated temperature of between about 200 to 500° F. (93.3 to 260° C.), and the strip enters the cooling apparatus 140 where it is rapidly cooled to prevent the prime coat from sticking to downstream rolls and equipment, for example but not limited to, the rolls in exit end accumulator 33, the shearer 36, and the recoiler 37. Rapid cooling prior to recoiling the prime-coated steel sheet also prevents sticking and pressure mottling “pickoff” of the primer between the laps of the recoiled prime-coated material. It should be understood, however, that in some instances, a particular prime coat material or mill configuration may allow recoiling of prime-coated steel sheet without active upstream cooling. For example, a thermoset epoxy or polyester primer may be sufficiently durable after curing and drying that it can contact rolls in the exit section 130 of FIG. 3 without being damaged. The length of sheet 2b in the exit section may allow for sufficient passive cooling prior to recoiling at 37. The acceptable temperature for recoiling at 37 the primed metal coated sheet 2b is dependent on the primer. In general, waterborne acrylics should be recoiled at approximately 100° F. (38° C.), while epoxy and polyester primers can be recoiled up to 200° F. (93° C.).

Primed and cured steel sheet product 2c may be cooled at 140 in a number of different ways. For instance, the cured prime-coated steel sheet may be cooled convectively with a blower arrangement 141 as shown in FIG. 3d at cooling apparatus 140. Blowers are widely used for convective cooling and can be designed to deliver a blast of cooling gases 142 satisfying the cooling requirements of the cured sheet. Accordingly, cooling blowers 141 may be used in combination with a supply of compressed gases and/or heat exchangers (not shown) that deliver chilled gases 142 to the cooling apparatus 140 so that cooling of the cured prime-coated steel sheet is accelerated. Blowers are easily installed, low maintenance equipment. Blower type convection cooling systems require long line lengths, however, and therefore increase the overall length of the coil coating section 131.

A second embodiment for cooling cured prime-coated steel sheet with cooling apparatus 140 is shown in FIG. 3e. This alternate embodiment comprises spray nozzles 143 that deliver a fine water mist 144 in combination with, or followed by, an air wipe 145 provided by blowers 146. The use of a fine water spray or mist 144 provides a faster cooling rate and therefore reduces line length requirements for the cooling apparatus 140 when compared with the length requirements for the forced gas cooling system delivered by blowers 141 in FIG. 3d. Resident heat in the cured strip 2c evaporates the impinging water mist 144 and the strip exits the cooling step 140 in a dry condition. Over spray is evacuated from the work environment. As an example, these types of cooling devices are available from Busch Company as JET STAR systems and are described in detail by Jacob in U.S. Pat. No. 5,697,169.

A third embodiment for cooling cured prime-coated steel sheet at 140 is shown in FIGS. 3a-3c and includes the use of chilled rolls 147 located immediately after the coating and drying/curing apparatus 138 and 139 respectively. Cured, primed-coated steel sheet 2c is less likely to stick to a chilled roll than to a roll that is not chilled. Therefore, the chilled rolls 147 may be positioned so that they contact the cured prime-coated steel sheet at the higher contact temperature immediately after the steel sheet exits the curing apparatus 139. Such chilled rolls remove excess heat from the cured steel sheet product before the sheet comes into contact with downstream processing rolls such as the rolls in the exit end accumulator 33. Higher allowable roll contact temperatures of about 300°-500° F. (150°-260° C.) allow reduction of the length of the cooling apparatus 140, thus providing greater design flexibility. If the chilled rolls are used to turn or redirect the strip (usually by 90°), additional cooling may be provided downstream using either forced gas or water mist cooling as described above for FIGS. 3d and 3e and/or the strip may pass through a water quench tank followed by hot air drying. It should be understood that the cooling apparatus 140 may comprise any variety or combination of cooling apparatus known in the art to reduce the temperature of the cured prime-coated steel sheet without departing from the scope of the present invention.

Mill application of a prime coat onto a pristine metal-coated surface of steel sheet product in a continuous hot-dip or electroplate coating line, as disclosed herein, eliminates chromate passivation, vanishing oils, edge sealants and packaging containing vapor phase corrosion inhibitors at the steel mill operation. The absence of such materials and processes reduces environmental impacts associated with coil coating metal-coated steel sheet products. Coil coated steel sheet manufactured in accordance with the present invention is more environmentally sound due to the absence of the waste materials, and is more cost efficient because the present invention eliminates various processing steps taught in the prior art as well as in the example shown in FIG. 1. Furthermore, the present invention allows for the elimination of the cleaning, pretreatment and primer steps from current coil coating operations shown in FIG. 2 and significantly reduces the number of pollution point sources associated with these current processes. Additionally, referring to Tables 1-5, coil coated steel sheet manufactured in accordance with the present invention exhibits excellent corrosion resistance and paint adhesion because the pristine metal-coated surface of hot-dip or electroplate coating is prime-coated immediately after the steel sheet exits the hot-dip coating or electroplating sections 100 or 120 of the line as shown in FIG. 3. It should also be understood that any one or more of the process steps described above for manufacturing prime-coated steel sheet, may be used to apply a prime coat, and that the cleaning, pretreatment and primer application, drying, curing, and cooling steps may be carried out with the metal coated steel sheet 2c traveling in either a vertical or horizontal direction.

Finish Coat

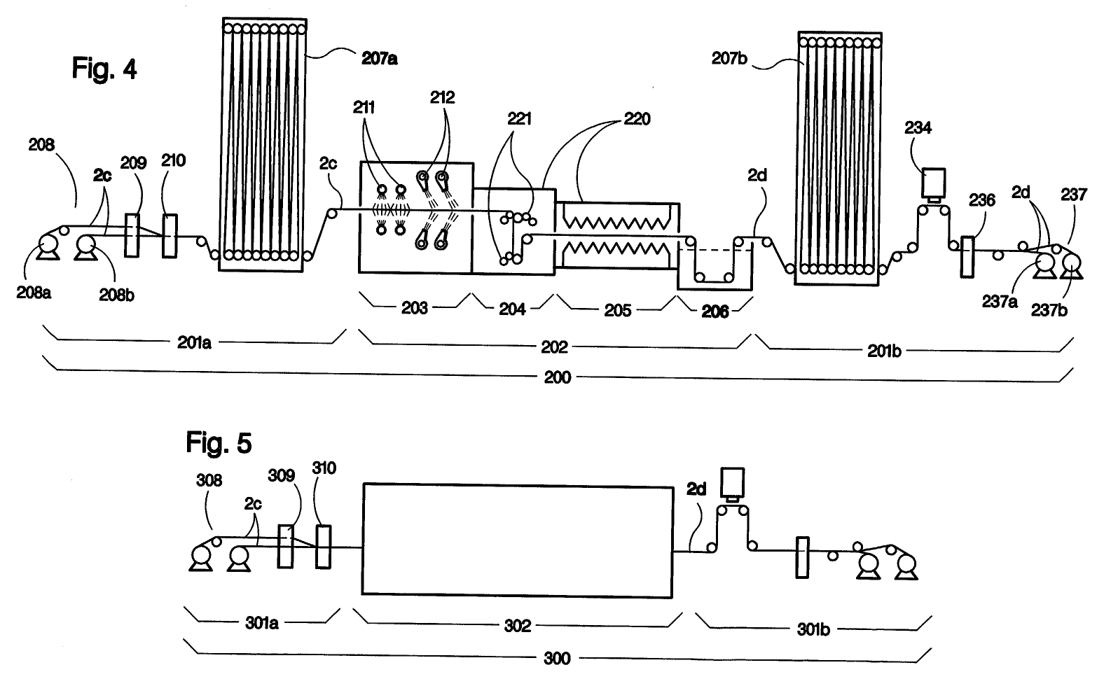

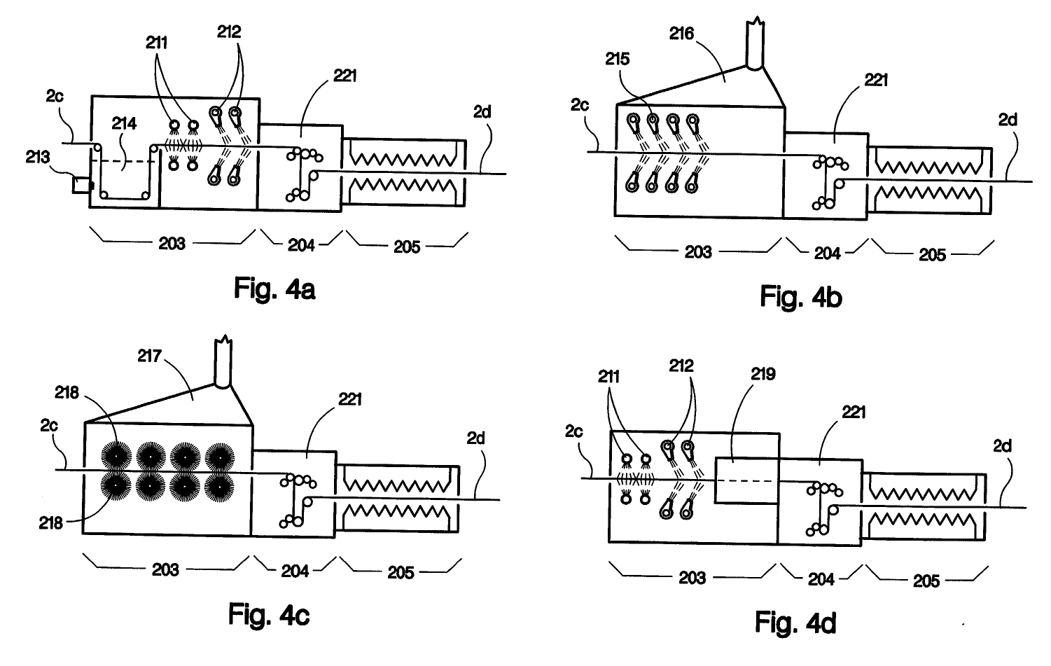

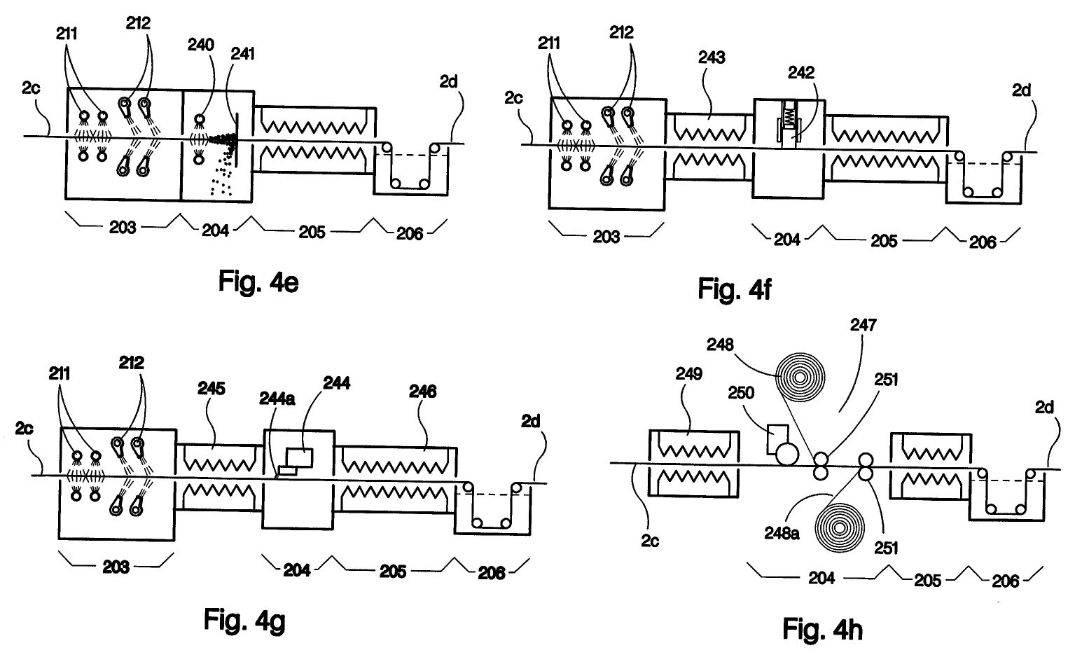

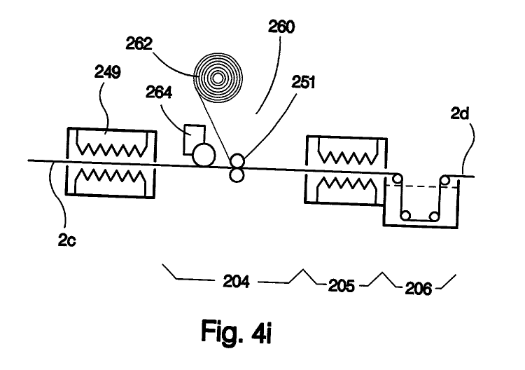

Referring to FIG. 4, in the preferred embodiment of the present invention, the prime-coated steel sheet 2c is further processed in a separate, environmentally benign, finish coating facility 200.

Finish coating facilities 200 that produce finish coated or painted steel sheet products according to the steps of the present invention, are substantially smaller when compared with state-of-the-art finish coating lines, for example as labeled 40 in FIG. 2. This is because in the present invention the prime coat has already been applied to the pristine metal-coated surface of the steel sheet product 2c at the steel mill continuous hot-dip coating or electroplating line. That is to say, the steel sheet is shipped from the steel mill in a preprimed condition. Environmental benefits realized from applying a prime coat directly to the pristine metal-coated steel sheet surface at the steel mill enables finish coating facility operators to eliminate the conventional cleaning steps 42, the pretreatment steps 43 or 61, and the priming steps 70 shown in FIG. 2 of the prior art paint line. Finish coating lines using mill preprimed sheet and applying finish coats, such as roll coater applied radiation (electron beam or ultraviolet) curable, electrostatic powder (see U.S. Pat. No. 5,279,863), solid block (see U.S. Pat. No. 5,281,435), laminate, or hot melt extrusion finish coats are environmentally benign facilities generating little or no solid, liquid and airborne pollutants. Steel mill application of a prime coat directly onto the metal-coated steel sheet surface also enables economical and environmentally-friendly production of sheet product with three organic (paint) coatings using conventional coil coating line operations with two coating stations as shown in FIG. 2. Moreover, because the steel sheet is already prime coated, it may be used potentially by end users and/or others who may finish coat it. The marketability of the product is thus greater than the conventionally produced product.

In FIG. 4 the finish coating line 200 comprises three sections or steps for applying a finish topcoat including: an entry end section 201a; a coating section 202 comprising a cleaning and surface modification station 203, a paint station 204, a drying and curing station 205 and a cooling station 206; and an exit end section 201b. There are several different possible configurations at each station to produce the same finish or topcoated steel sheet product 2d. The following embodiments of the present invention describe applying a single finish or topcoat to the preprimed steel sheet product 2c. It should be understood, however, that any of the following embodiments may be used to apply more than one finish coat to the preprimed surface, for example, two or more coats, without departing from the scope of the present invention.

Referring again to FIG. 4, the preferred finish coating line embodiment includes an entry end accumulator 207a and an exit end accumulator 207b that cooperate to maintain constant line speed in coating section 202 of the finish coating line 200 as described above for the prior art. It should be understood, however, that a start-stop type finish coating line, shown as 300 in FIG. 5, may be used to apply a finish coat according to the steps of the present invention. Finish coating line 300 includes an entry end section 301a, a coating section 302, and an exit end section 301b but does not include the accumulators 207a and 207b shown in FIG. 4. Such start-stop lines lower capital costs and reduce line size. The selection of a continuous line 200 or a start-stop line 300 is dependent upon a variety of factors including product mix, coating compositions, coating application methods, number of finish coats applied and budgetary and space constraints.

Whether the finish coat is applied on a continuous line (FIG. 4) or start-stop line (FIG. 5), the coils are paid off from the entry uncoiler 208 or 308. In most instances, the uncoiler provides for the loading of two coils 208a and 208b so that the leading end of one preprimed coil may be joined to the tail end of a preceding preprimed coil with minimal delay. In a continuous line 200, the stationary ends of the coils are cut in shear 209 and spliced together at 210, with only the entry end 201a stopped while the accumulator 207a maintains a continuous and constant sheet speed through the coating section 202 by feeding accumulated sheet into coating section 202. The accumulators provide means for coil changes with no interruption in the finishing operation. In the start-stop line 300, the entire finish line is stopped until the lead and tail ends of the old and new coils are cut in shear 309 and fastened together, for example, by welding, in splicer 310. After the lead and tail ends of the preprimed coils 2c are spliced together, the preprimed material is paid out directly into coating section 302 for finish coating. In the continuous line 200, the new coil is paid out through the entry accumulator 207a and then into the coating section 202 for finish coating.

Although the following descriptions and embodiments are directed to the continuous finish coating line operation shown in FIG. 4, it should be understood that the described embodiments may be applied to the start-stop finish line operation shown in FIG. 5 by those having ordinary skill in the art, and that such application in a start-stop line is not a departure from the present invention.

Referring once again to FIG. 4, the cleaning and surface modification station 203 provides an optional first process step for applying a finish coat following the entry end section 201a of the line. The cleaning step may be omitted if high quality clean preprimed sheet is delivered to the finish coat process. A number of different processes may be used to clean and modify the surface of the preprimed metal-coated steel sheet 2c before the finish coat is applied at the painting station 204. In the present invention, surface cleaning refers to removal of loose debris from the strip surface. Surface modification refers to a physical and/or chemical alteration of the primer surface to enhance wetting and adhesion of a finish coat applied to the prime-coated surface, without altering the bulk chemistry or physical properties of the primer. Surface cleaning and surface modification of the prime-coated steel sheet 2c may include any of the process methods described below, all of which are applicable to both continuous and start-stop finish coating lines.

In a first exemplary embodiment for finish coating preprimed steel sheet 2c, if incoming preprimed sheet is properly packaged, handled and protected at the hot-dip coating or electroplating line, as well as during storage and/or shipment to the finish coating line, no surface cleaning or surface modification of the prime coat is necessary. In such an instance, the coil proceeds directly from the payoff reel of the uncoiler 208 and onto the accumulator 207a, where it is fed into the finish coating section 202 in the absence of any cleaning and/or surface modification. Such a finish coat process, without a cleaning and surface modification station 203, provides a shortest length and least expensive continuous coating line embodiment. Absent a cleaning and surface modification station 203, such coating line lacks flexibility for handling product quality inconsistencies detected in incoming preprimed sheet material, but will not generate the waste streams or have environmental, health and safety issues associated with other embodiments that include cleaning and surface modification of the prime-coated surface.

If some surface cleaning of the prime-coated steel sheet 2c is desirable, a cleaning station 203 may be provided as shown in FIG. 4. Such cleaning apparatus may comprise spray nozzles 211 that provide a simple pressurized water spray wash sufficient to remove any loose debris from the preprimed surface of the steel sheet. Additionally, if necessary to loosen clinging debris, a mild emulsifying detergent solution may be used. Such detergent washing typically is followed by a second water spray rinse (not shown). Incoming prime-coated steel sheet 2c should not have substantial amounts of dirt or debris on its primed surface. Therefore, the rinse water may be filtered to remove particulates and then recirculated in a closed loop wash system. The filtrate from such recycled rinse water will not contain hazardous materials. It is possible, however, that some leaching of chromate corrosion inhibiting compounds may occur, and the filtrate should be monitored from time to time to avoid environmental problems. Suspect chromate-containing filtrate and associated liquid waste streams should be handled and disposed of properly. The amount of liquid and solid waste generated in the present finish coat embodiment is substantially less than the liquid and solid waste generated in current state-of-the-art finish coating lines that are required to clean and abrasively brush chromate passivated metal-coated steel sheet that is not prime-coated at the steel mill. After water rinsing, the sheet passes between dryers 212 and is dried using either hot air or infrared dryers in a manner obvious to those skilled in the art.

In the embodiment of FIG. 4a, cleaning and drying of the incoming prime-coated steel sheet 2c is carried out using ultrasonic strip cleaning apparatus as described by Swainbank in U.S. Pat. No. 4,788,992. Such cleaning apparatus 213 provides continuous cleaning of the prime-coated surface using ultrasonic excitation while the strip is in contact with a cleaning solution 214. The system also incorporates water spray rinsing and air wiping to blow dry the sheet. This process is a compact system and consumes less cleaning solution and power when compared to conventional spray wash methods.

In the embodiment illustrated in FIG. 4b, a dry cleaning method comprises a “blow-off” system that cleans the prime-coated surface of incoming steel sheet 2c. The blow-off system is shown using transvectors 215 to blow any loose debris from the primed surface. The system uses vacuum hood 216 to collect the blow-off air, along with loosened air borne particulate matter (debris), in a bag house (not shown) for disposal.

Referring to FIG. 4c, a second exemplary dry cleaning method that may be used to clean the surface of primed sheet 2c is described by DeRosa in U.S. Pat. No. 5,980,646. DeRosa teaches a continuous web cleaning process that uses a vacuum in combination with brushing to remove dust and chad from paper. A similar cleaning process that applies a vacuum in combination with a light, soft brush action may be used to clean the prime-coated surface of the present invention. In such an application of the DeRosa process, the air stream associated with the vacuum is collected in a hood 217 and discharged away from the work environment. If required, the discharge air streams may be filtered and the particulate collected in a manner obvious to one skilled in the art. The brushes 218 must be nonabrasive to the prime-coated surface, and they should only be used to lift loose clinging particles so that the vacuum is able to carry the lifted particles away from the strip.

Two additional dry cleaning methods suitable for cleaning prime-coated steel sheet are described in U.S. Pat. Nos. 4,454,621 and 5,596,783 to Testone, and in U.S. Pat. No. 5,916,373 to Schneider. Testone teaches removal of dust particles that are statically adhered to the surface of prime-coated sheet or web. The sheet material is cleaned by blowing ionized air onto the sheet surface and the airborne particulate matter is removed by suction. Schneider describes a dry method for removing particulate matter from a sheet surface using a blower and suction device to lift and remove dust particles from a web surface. The patent teaches application of an ultrasonic gas flow in the blower unit and potential biasing of the sheet surface to effect discharge of the adhered particles. Electrostatic forces between the contaminant particle and the sheet surface are overcome by the potential biasing and the van der Waals forces are overcome by the ultrasonic gas flow. The Testone and Schneider apparatus would appear similar to the apparatus illustrated in FIG. 4b, and therefore, a figure has not been provided for these embodiments.

The different dry cleaning methods and apparatus described above are environmentally benign in that they neither generate nor discharge liquid waste streams, and only a small amount of non-hazardous particulates is generated during the dry cleaning process. Such non-hazardous particulates require no treatment or handling other than possibly air filtration. If extremely low levels of particulate matter are generated, the process air may be discharged directly to atmosphere. Even though such solid waste material is considered non-hazardous, the material does require characterization, proper handling and disposal. In general, dry cleaning processes require minimal capital investment, their maintenance costs are low, and they are considered safe and economical with respect to waste treatment and handling.

Referring to FIG. 4d, in certain instances it may be advantageous to modify the chemistry of the prime-coated surface so that its surface energy is altered to achieve optimized paint wetting and paint adhesion when the finish coat is applied to the preprimed sheet 2c. Such energy surface modification apparatus 219 is positioned along the cleaning and surface modification section 203 at a location downstream from the dryer apparatus 212. An increase in surface energy is achieved by incorporation of polar functional groups into the prime coat surface, and surface energy modification is performed using any one of the processes described below or any other surface modification process not mentioned below but known by those skilled in the art. Selection of a particular surface modification process is dependent upon the requirements associated with the finish coating line, the prime coat surface that was applied at the steel mill, the particular finish coat application method and the properties of the finish coat.

The current state-of-the-art provides numerous wet chemical methods that may be installed as the surface energy modification apparatus 219 to alter the surface energy of the sheet, especially if the process is used in conjunction with a wet cleaning cycle. Such processes include the use of solvents, strong acids, strong bases or other surface modifying agents. Such wet chemical processes have some degree of environmental, health and safety risk associated with their use, and their chemical reaction is often unreliable, non-uniform, difficult to control, and difficult to reproduce. Therefore, in keeping with the objects of this invention, and although a wet chemical process may be used in a finish coating line, such wet chemical processes are less than desirable.

A more preferred method for altering the surface energy of a prime-coated steel sheet comprises an environmentally benign dry surface modification method that generates no liquid waste streams. One such dry method comprises a flame treatment device installed as the surface energy modification apparatus 219. In this embodiment, the prime-coated steel sheet moves through an array of burners so that the flames oxidize the prime-coated surface and thereby increase its surface energy to promote wetting and adhesion of subsequent finish coatings. Flame treatment may be conducted with the sheet running either in a vertical direction or in a horizontal direction. Contact time, burner conditions, and flame distance from the sheet are dependent on specific line conditions as well as prime coat and finish coat properties and compositions. Exemplary gases that may be used to carry out flame treatment are natural gas, methane, propane, and butane. Gas choice and burner parameters are determinable by one skilled in the art. Flame treatment systems can be obtained from a number of suppliers including Sherman Treaters Incorporated and Flynn Burner Corporation. Since flame treatment oxidizes the surface, no VOC are produced by the process and exhaust gases may be safely vented directly to atmosphere. Specific safety precautions are required to close off the open flame treatment area and to properly isolate the gas stream from the work environment. Such processes are simple and are widely used in the paper and plastics packaging industry.

An alternate surface energy modification apparatus 219 comprises a corona discharge device installed at cleaning station 203. Corona discharge treatment utilizes an ionized gas to modify the functionality of a polymer surface and thereby alter its surface energy. The gas ionization is accomplished using high voltage electrodes in close proximity to a grounded surface (the prime-coated steel strip). Generally, at least one of the electrode surfaces must have a dielectric coating. At a high enough voltage, the gas in the gap between the electrode and the grounded surface is ionized. The ionized gas reacts with the polymer substrate through oxidation reactions and direct ion sputtering of the surface. Some UV radiation is also produced which may cause reactions in the polymer surface. Corona discharge treatment utilizes free air and generates ozone as a by-product. Ozone capture and removal from the work environment, and possibly destruction, is typically utilized for the corona discharge process. This process is also used widely in the paper and plastics packaging industry. Corona treatment systems can be obtained from a number of suppliers including Sherman Treaters Incorporated, Enercon Industries Corporation and Pillar Technologies. Corona treatment is widely used to increase surface energy for promoting adhesion of coatings or printing inks to polymer webs as described by Stuart Grieg of Sheman Treaters in “Web Treatment—Going Solventless.”

Another surface energy modification apparatus 219 comprises a glow discharge or plasma treatment device installed in cleaning station 203. Such devices form a plasma by ionizing a gas in an electric field, usually at a radio frequency and under vacuum. The effect of the plasma treatment depends upon the nature of the surface to be treated, and may be tailored by altering the energy, density and type of species in the discharge by suitable choice of excitation frequency, net power, current density and gas/vapor mixture, pressure, and flow rate. For example, surface energy can be increased by plasma-induced oxidation, nitration, hydrolyzation or amination. It can also be decreased by plasma induced fluorination. Glow discharge processes generally require isolation of the reaction chamber and process gases/vapors from the ambient environment. The process requires increased complexity and cost but is still compact relative to conventional paint line pretreatment sections. If oxygen is a component of the gas, ozone may be a by-product, and may require collection and destruction prior to being vented to the atmosphere. Recently, atmospheric pressure glow discharge treatment techniques and apparatus have been developed that eliminate the need for a vacuum chamber. Currently, such techniques require large amounts of relatively expensive helium gas for a stable discharge, although some progress has been made on a small scale towards substitution for less expensive stabilizing gases. Plasma treatment systems can be obtained from a number of suppliers including Corotec Corporation and Enercon Industries Corporation.

Other dry method embodiments that may be installed as surface modification apparatus 219 include electron beam, ultraviolet oxidation, and vacuum ultraviolet treatment devices. Such devices, as well as treatment with a glow discharge of an unreactive gas, such as argon, generally cause the formation of surfaces that incorporate oxygen upon exposure to the atmosphere. For example, ion beam treatment may be used to alter surface energy if the beam is inert. Ion beams may also be used for direct incorporation of specific chemical species into the treated surface. Ozonation is another dry surface modification technique that may be used to incorporate oxygen directly into the surface. In general, these methods are more compact and more environmentally friendly than current state-of-the-art pretreatment methods. Some of the above methods are developmental and may have severe limitations in terms of compatibility with processing the sheet products, applied primers, and finish paints used in this process.

After the above optional cleaning and surface modification steps are carried out, the primed, metal coated sheet is finish coated at 204 using one of a variety of different coating apparatus. The specific desired finish-coated product, required degree of flexibility, space availability, costs, and environmental and safety compliance issues determine which apparatus and method is selected to apply the finish coat. Environmental impacts related to applying a finish coat according to the steps of the present invention may vary substantially based upon the apparatus and method selected for finish coat application. Since the present invention applies a finish coat to a preprimed metal-coated steel sheet, however, environmental impacts at the finish coat line are substantially reduced when compared to state-of-the-art conventional finish coat methods. Therefore, any one of the embodiments described below may be installed as finish coating apparatus at station 204, in either a continuous line 200 or a start-stop line 300, to carry out the steps for applying a finish coating. It should be understood that although the following descriptions and embodiments teach application of a single finish coat to the preprimed surface of the metal-coated steel sheet, multiple finish coat layers may be applied to the preprimed surface without departing from the scope of the present invention.

The first embodiment for applying a finish coat to the primed sheet is shown in FIG. 4 and comprises a roll coating device 221 installed at coating station 204 to apply a solvent borne coating. The exact roll coating technique is determinable by one skilled in the art. The roll coating device 221 may comprise either a direct roll or a reverse roll coating method. If a print type finish coat is desired, a gravure process or the like may be used to apply a desired print pattern. The solvent borne finish coat may be dried and/or cured at station 205 using either induction, infrared or convection ovens. After drying and curing, the sheet may be cooled at station 206, usually by quenching. Alternatively, convection air cooling or water spray cooling may be used to cool the dried and cured finish coated sheet. Depending on the specific finish coat and the temperature at which it is cured/dried, active cooling may not be required. In applications where a solvent borne finish coating is applied, a total permanent enclosure 220 is provided to house the coating apparatus 221. Capture and destruction equipment would typically be utilized for VOC emitted from the finish coating station 204 and the drying and curing station 205. Such roll coating processes reduce environmental impact over conventional coil coating facilities because they eliminate the “wet section,” for example, the cleaning 42 and pretreatment 43 sections shown in FIG. 2, and their associated liquid and solid waste streams. Costs associated with providing an enclosure 220 and VOC capture and destruction equipment are similar to such costs in a conventional coil coating line.

The above described roll coat apparatus may also be used for the application of a low VOC (VOC less than about 2.6 lb/gal, or 0.31 kg/liter of coating solids) compliant waterborne coating. Such roll coating techniques are known to those skilled in the art, and include either direct roll or reverse roll coating methods. Such compliant waterborne coatings applied to preprimed metal-coated steel sheet may also be dried and/or cured at station 205 as described above using induction, infrared or convection ovens. After drying and curing, the sheet may be cooled, if necessary, at station 206 by quenching, convection air-cooling or water spray cooling. Application of compliant waterborne coatings eliminates any need for destroying VOC by incineration. Environmentally compliant waterborne coating processes provide an improvement over conventional coil coating facilities because they eliminate VOC incineration and the liquid and solid waste streams associated with the wet section. The initial capital costs associated with the installation of a finish coat line applying compliant waterborne coatings according to the present invention are substantially less than the initial costs of a conventional coil coating line. Additionally, line length requirements are lessened because the conventional wet section or cleaning section 42 (FIG. 2) is eliminated.

Roll coating apparatus 221 may also be used to apply a radiation curable finish coat to preprimed metal-coated steel sheet. Such radiation curable coatings are cured by proper exposure to either an electron beam (EB) or to ultraviolet (UV) radiation. EB radiation curing is nearly instantaneous, while UV curing requires some coating exposure time. Both UV and EB coatings are solvent free. Therefore, no VOC recovery is required along the coating station 204 as well as along the drying/curing sections 205. The process for applying EB and UV curable finish coatings according to the present invention eliminates liquid and solid waste streams associated with the above-described conventional wet section 42 of FIG. 2. The radiation curable finish coat process of the present invention also eliminates the cleaning and pretreatment sections that are required to remove oils and passivates applied at the steel mill as described by Madigan in U.S. Pat. No. 6,004,629 for his EB coating process. The Table 6 test results show that the corrosion and adhesion performance of preprimed Galvalume sheet with an EB finish coat is superior to an EB finish coat over PPG OrganoKrome 2000, described by Madigan.

TABLE 6
Paint adhesion (ASTM D415-83) and salt spray corrosion performance (ASTM B117-95) for
fully painted Galvalume. T-bend adhesion given as number of T-bends to achieve no paint
removal by tape pull. All samples finish coated with e-beam curable topcoats.

| | | | | Paint Lifting (mm) | | | |
|---|---|---|---|---|---|---|---|
| Primer | | | T @ no | Cut Edge | | Scribe | |
| Supplier | Name | Type | Tape off | Max. | Avg | Max | Avg. |
| Technical | Q-coat | Waterborne Epoxy | 2T | 3.7 | 1.8 | 3.3 | 0.4 |
| Coatings | | | 5T | 1.8 | 0.5 | 0.5 | 0.0 |
| | | | >7T | 2.1 | 0.7 | 0.0 | 0.0 |
| Lilly | 632-L-144 | Waterborne | 0T | 8.6 | 2.0 | 0.0 | 0.0 |
| | | Acrylic with some | >7T | 5.8 | 1.8 | 1.0 | 0.1 |
| | | co-solvent | 0T | 3.1 | 0.5 | 0.3 | 0.1 |
| | | | 0T | 4.3 | 1.0 | 0.8 | 0.2 |
| Akzo Nobel | 9X444 | Solvent Borne | 4T | 3.7 | 1.3 | 2.2 | 0.2 |
| | | Epoxy | 4T | 4.7 | 1.1 | 0.9 | 0.2 |
| | | | >7T | 2.0 | 0.7 | 0.0 | 0.0 |
| | | | 7T | 3.0 | 1.1 | 0.3 | 0.1 |
| PPG | OrganoKrome 2000 | Waterborne | >7T | 21.3 | 9.6 | 16.3 | 9.1 |
| | | Acrylic | >7T | 23.4 | 8.2 | 7.7 | 4.9 |
| | | | >7T | 19.6 | 8.1 | 8.2 | 4.9 |
| | | | >7T | 30.0 | 10.0 | 12.1 | 7.0 |
| | | | >7T | 29.0 | 10.0 | 19.0 | 10.0 |
| | | | >7T | 28.5 | 10.0 | 25.0 | 10.0 |

Additionally, because the EB and UV processes cure the finish coat by radiation, there is no substantial heating of the metal substrate. The “cold curing process” enables the finish coated metal to move downstream, without cooling, quenching or drying, directly to the exit end 201b for inspection at station 234, shearing at station 236 and recoiling at station 237 where the finish coated steel sheet product 2d is recoiled and wrapped for storage and/or shipping. The EB or UV finish coating process requires very little space or environmental control equipment. Therefore, the EB/UV finish coating process described herein is economical, environmentally sound, and more efficient than conventional coil coating lines, or the improvements taught by Madigan.

A limitation of UV curing of coatings is reduced curing efficiency caused by interference of UV radiation by pigment particles in the coating formulation. One method to increase efficiency of curing is to simultaneously apply infrared (IR) and UV radiation. IR and UV curing units can be specified and supplied by companies such as ITW BGK and Fusion UV systems, Inc., respectively.

A different embodiment for applying a finish coat to a preprimed metal-coated steel sheet comprises an electrostatic spray, tribostatic spray or electrostatically charged powder chamber device 240, having a baffle 241, installed as the coating apparatus at station 204 in FIG. 4e. Such devices, for example, but not limited to, electrostatic sprays, apply a powder that is further processed to provide a finish coat. One such method suitable for use in applying a powder coating to the preprimed surface of a metal-coated steel sheet is described by Escallon in U.S. Pat. No. 5,279,863. After a powder coating is applied electrostatically to the preprimed surface, it is then melted and flowed into a continuous polymer coating layer and cured by means of an induction, infrared or convection oven or the combination of infrared and ultraviolet ovens. After curing, the sheet is cooled at station 206, if necessary, by quenching, convection air-cooling or water spray cooling. A coil coating line that electrostatically applies a powder finish coat on a preprimed steel sheet according to the present invention has no wet section and emits almost no VOC. An electrostatic powder coating process is more than 95% efficient with respect to powder use in applying the finish coat (D. L. Ulrich, Users Guide to Powder Coating, Society of Mfg. Eng., 1993). The use of preprimed metal-coated steel sheet in combination with powder coating techniques eliminates almost all liquid waste, VOC, HAP compounds, and solid waste streams. The surface cleaning/modification station 203 and the finish coat station 204 of a powder coating line require very little space relative to a conventional coating line, or when compared with other powder coating lines that continue to use past surface treatment and finish coat techniques similar to the method taught by Escallon. Elimination of the FIG. 2 wet section 42 and the FIG. 2 primer section 70 from a powder coating line also reduces the cost of the coating line.

Another embodiment for applying a finish coat to the preprimed surface on a metal-coated steel sheet includes the use of a solid block coating device 242 installed as the finish coating apparatus at station 204 in FIG. 4f. Optionally, there is a block coating device 242 for each surface or side of the strip 2c, with the devices being spaced along the strip on their respective sides. Solid block coaters as described in U.S. Pat. No. 5,281,435 to Buecher are used to apply solvent-free paint layers as described in U.S. Pat. No. 6,130,273 to Edwards to a primed substrate. In the present embodiment, the preprimed steel sheet 2c is preheated to a coating temperature within a range of between about 212° to 410° F. (100° to 210° C.), with a preferred preheated coating temperature of about 320° F. (160° C.), prior to its entry into the solid block coater. An infrared, convection, or induction furnace 243 may be used to preheat the preprimed steel sheet. After the block coater 242 applies the solvent free finish coat to the preprimed surface, the finish coat is cured at station 205 followed by cooling at station 206. Selection of a proper preheated coating temperature is dependent upon the combination of the desired line speed and primer and solid block coating properties. Such preheat temperatures are determinable by one skilled in the art. Because solid block coating processes use no solvents, VOC control technology may be eliminated from the solid block coating line. For example, Buecher teaches using a solid block coating process where maximum painted sheet performance is achieved through the use of a conventional pretreatment and primer technology that necessitates VOC, liquid waste and solid waste control equipment. In the present invention, where a solid block coating is applied to a preprimed metal-coated steel sheet, almost no VOC, solid waste or liquid waste is generated by the coating process, thereby enabling operation of the present solid block coating line without waste-stream collection and control apparatus associated with Buecher or other conventional coil coating lines as described above. The present solid block coating process for painting a preprimed steel sheet provides an environmentally benign finish coating facility where the line speed is only limited by the requirements of the solid block finish coating apparatus. Such solid block coil lines are less capital intensive, require less space, are not rate limited by the cleaning and pretreatment processes or roll coater application of the primer. Such lines are also capable of running at line speeds of up to 670 ft/min (200 m/min) and are more environmentally compliant than originally proposed by Buecher. Because of the corrosion inhibiting pigments contained in the primer, the preprimed and solid block finish coated substrate is a more durable product for demanding service conditions, such as marine or industrial environments, than compared to an unprimed substrate with only a solid block coating.

Referring to FIG. 4g, a different coater embodiment for applying a finish coat includes a slot die coating device 244 that applies a hot melt coating 244a to the preprimed metal-coated steel sheet 2c as it moves through coating station 204. Hot melt coatings are also solvent free and are generally applied using a slot die coater. Hot melt coatings are applied to the preheated preprimed sheet by extruding the melt through a slot. Optionally, there is a slot die coating device 244 for each surface or side of the strip 2c, with the devices being spaced along the strip on their respective sides. After the melt 244a is deposited onto the preprimed surface of the steel sheet, it may be crosslinked by further heating (post heating) or the sheet may be cooled immediately without any crosslinking. Similar to the above solid block coating method, appropriate treatment, heating and cooling is dependent upon line speed and line length as well as the hot melt coating chemistry, primer properties, and are determinable by one skilled in the art. Both preheating and post heating may be accomplished using induction, infrared, or convection furnaces 245 and 246 respectively. After the hot melt coating is applied and in some cases cured, the sheet is cooled at station 206 by quenching, convection air cooling, or water spray cooling. As described for solid block coating, slot die hot melt coating techniques eliminate the need for solvent recovery technology associated with past coating lines. The use of preprimed metal-coated steel sheet in combination with slot die hot melt coating techniques also eliminates any need for a wet section 42 and primer section 70 as shown in FIG. 2. The present slot die hot melt coating line for preprimed metal-coated steel sheet is more compact than conventional coil coating lines, requires little or no environmental control equipment, and is more cost effective and environmentally sound.

Another exemplary embodiment, shown in FIG. 4h, applies a finish coat to the preprimed metal-coated steel sheet 2c using a dry laminating device or devices 247 installed at coating station 204. Device 247 applies a laminate film 248 to the prime coat surface of the steel sheet. Such laminate films are applied in the solid condition, and they contain no solvents. The laminates are joined to the preprimed steel sheet using heat setting and/or radiation curable adhesives that are present on the surface of the laminate film 248. In the dry laminate application process, the preprimed steel sheet 2c is preheated in furnace 249. The laminate material 248 is uncoiled and roll pressed onto a surface of the heated preprimed steel sheet using, for example, pinch rolls 251. The laminated product may be further heated and/or exposed to UV or EB radiation at station 205 to cure the adhesive. The laminated product is cooled at station 206, if needed, before recoiling, usually by quenching. Convection air cooling or water spray cooling may also be suitable. Lamination processes that use heat activated adhesives also eliminate VOC from the finish coating line. When a heat activated adhesive is pre-applied to a laminate surface, the process requires no handling of liquid coating materials, and the coating process requires only preheating of the preprimed metal-coated steel sheet 2c. Such lamination processes do not require environmental control equipment, they are compact facilities, and are capable of running at relatively high line speeds of about 1000 ft/min (300 m/min) or faster. The present invention process for laminating a film to a preprimed steel sheet is also environmentally benign and cost effective because of the reduced line space and equipment requirements, and the resulting faster line speeds increase productivity. In other words, the laminate coating process of the present invention reduces environmental impact and improves cost and production efficiency when compared to conventional coil coating lines or past metal laminating processes.

A final exemplary embodiment, shown in FIG. 4i, applies a finish coat to the preprimed metal-coated steel sheet 2c using a liquid laminating device or devices 260 installed at coating station 204. Device 260 applies a laminate film 262 to the prime coat surface of the steel sheet. Such laminate films are applied in the solid condition, and they contain no solvents. The laminates are joined to the preprimed steel sheet using thermoplastic, heat setting and/or radiation curable adhesives that are applied to the preprimed sheet 2c or the laminate material 262 using either a roll coater or slot/die type coater 264. The adhesive, although applied as a liquid, contains no carrier solvents. The laminate material 262 is uncoiled and roll pressed onto the coated preprimed steel sheet using, for example, pinch rolls 251. The laminated product is then heated and/or exposed to EB radiation to cure the adhesive at station 205. The laminated product is cooled, if necessary, at station 206 before recoiling. Cooling at 206 is usually by quenching, although convection air cooling, or water spray cooling may also be suitable. The lamination processes that use solvent-free liquid adhesives also eliminate VOC from the finish coating line. Such lamination processes do not require environmental control equipment, they are compact facilities, and are capable of running at relatively high line speeds of about 1000 ft/min (300 m/min) or faster. The present inventive process for laminating a film to a preprimed steel sheet is also environmentally benign and cost effective because of the reduced line space and equipment requirements, and the resulting faster line speeds increase productivity. In other words, the laminate coating process of the present invention reduces environmental impact and improves cost and production efficiency when compared with conventional coil coating lines or past metal laminating processes.

Referring again to FIG. 4, after one of the above disclosed finish coats is applied to the preprimed metal-coated steel sheet 2c at coating section 202, the finish coated product 2d moves downstream to the exit end accumulator 207b that cooperates with the entry end accumulator 207a to maintain a constant line speed as described above. The finish coated steel sheet passes through an inspection station 234 that provides an operator with an unobstructed view of the finish coated product before it enters shear 236. At shear 236, the sheet is cut to length after it is rewound to a proper coil size on the recoiler 237. In the continuous line shown at 200, there are usually two recoilers 237a and 237b at exit end section 201b so that when the finish coated steel sheet 2d is sheared at station 236, the free end may be quickly threaded onto the empty recoiler with minimal stop time before the exit end 201b is restarted. The recoiled finish coated steel sheet product is removed from the recoiler 237, and the finish coil of steel sheet product is wrapped for storage and/or shipping to a customer.

While this invention has been described as having a preferred design, it is understood that the invention is capable of further modifications, uses, and/or adaptations which follow in general the principal of the present invention and includes such departures from the present disclosure as come within known or customary practice in the art to which the invention pertains and that may be applied to the central features here and before set forth and fall within the scope of the limits of the appended claims.

We claim:

1. A process for applying at least one finish coating on a continuous prime-coated (preprimed) steel or metallic-coated steel sheet, comprising the steps of:
a) providing a sheet of steel having a prime coat applied to a pristine metal-coated surface of the steel; and
b) applying a finish coat to at least a first surface of the prime coated steel sheet and thereby producing a finish coated sheet.

2. The process of claim 1, including the step of applying the finish coat using a roll coater.

3. The process of claim 2, including the step of providing a finish coat that is solvent borne, the solvent including an organic solvent.

4. The process of claim 2, including the step of providing a finish coat that is waterborne.

5. The process of claim 1, including the steps of:
a) preheating the prime coated steel sheet to a predetermined temperature; and
b) pressing a solid paint block against the preheated prime coated surface and thereby forming the finish coat.

6. The process of claim 1, including the step of applying the finish coat as an electrostatically applied powder coating.

7. The process of claim 1, including the steps of:
a) preheating the prime coated steel sheet to a suitable temperature; and
b) depositing a hot melt coating onto the preheated prime coated steel sheet and thereby forming the finish coat.

8. The process of any one of claims 1-7, including the step of curing the finish coat using convection heating.

9. The process of any one of claims 1-7, including the step of curing the finish coat using induction heating.

10. The process of any one of claims 1-7, including the step of curing the finish coat using infrared (IR) radiation.

11. The process of any one of claims 1-7, including the step of curing the finish coat using a process selected from the group consisting of convection heating, induction heating, infrared radiation, and combinations thereof.

12. The process of claim 2, including the step of providing a finish coat that is a 100% solid radiation curable coating.

13. The process of claim 12, including the step of curing the finish coat using electron beam radiation.

14. The process of claim 12, including the step of curing the finish coat using ultraviolet radiation.

15. The process of claim 12, including the step of curing the finish coat using a combination of ultraviolet and infrared radiation.

16. The process of claim 12, including the step of curing the finish coat using a curing process selected from the group consisting of convection heating, induction heating, infrared radiation, electron beam radiation, ultraviolet radiation, and combinations thereof.

17. The process of claim 1, including the step of applying the finish coat as an adhesively secured laminate film.

18. The process of claim 17, including the step of providing a laminate film having pre-applied adhesive as a backing film.

19. The process of claim 17, including the step of applying the adhesive in-line to at least one of the laminate film and the prime coated steel sheet.

20. The process of claim 19, including the step of selecting as the adhesive an adhesive selected from the group consisting of hot-melt adhesive, heat curable adhesive, and radiation curable solid adhesive.

21. The process of claim 17, including the step of applying the adhesive at a nip-point where the prime coated steel sheet is joined with the laminate film.

22. The process of claim 21, including the step of selecting the adhesive from the group consisting of hot-melt adhesive, heat curable adhesive, and radiation curable solid adhesive.

23. The process of claim 17, including the steps of:
a) preheating the prime coated steel sheet;
b) applying the laminate film to the preheated sheet; and
c) cooling the joined laminate film and prime coated sheet.

24. The process of claim 17, including the step of heating the joined laminate film and prime coated sheet sufficiently to cure the adhesive.

25. The process of claim 17, including the step of curing the adhesive with electron beam radiation.

26. The process of claim 17, including the step of curing the adhesive with ultraviolet radiation.

27. The process of claim 1, including the step of rinsing the prime-coated sheet prior to application of the finish coat.

28. The process of claim 1, including the steps of rinsing and drying the prime-coated sheet prior to application of the finish coat.

29. The process of any of claims 27 and 28, including the step of washing the prime coated sheet with a cleaning solution prior to the rinsing step.

30. The process of claim 1, including the steps of:
a) contacting the prime coated sheet with a cleaning solution;
b) ultrasonically exciting the prime coated sheet while in contact with the cleaning solution; and
c) thereafter drying the prime coated sheet prior to application of the finish coat.

31. The process of claim 1, including the step of impacting a gas against the prime coated sheet prior to application of the finish coat.

32. The process of claim 31, including the step of providing air as the gas.

33. The process of claim 32, including the step of providing ionized air as the gas.

34. The process of claim 31, including the steps of directing the gas at an ultrasonic rate and applying a vacuum contemporaneously with said impacting step.

35. The process of claim 1, including the step of modifying the prime coated sheet to improve its paint wetting and adhesion properties using a dry surface modification method prior to application of the finish coat.

36. The process of claim 35, including the step of using flame oxidation as the modification step.

37. The process of claim 35, including the step of exposing the prime coated sheet to ultraviolet radiation.

38. The process of claim 37, including the step of applying the ultraviolet radiation in the presence of a vacuum.

39. The process of claim 35, including the step of exposing the prime coated sheet to corona discharge.

40. The process of claim 35, including the step of exposing the prime coated sheet to glow discharge.

41. The process of claim 40, including the step of performing the glow discharge in the presence of a vacuum.

42. The process of claim 35, including the step of exposing the prime coated sheet to electron beam radiation.

43. The process of claim 42, including the step of applying the electron beam in the presence of a vacuum.

44. The process of claim 1, including the step of modifying the prime coated sheet to improve its paint wetting and adhesion properties using a wet chemical surface modification method prior to application of the finish coat.

45. The process of claim 44, including the step of exposing the prime coated sheet to a strong acid prior to application of the finish coat.

46. The process of claim 44, including the step of exposing the prime coated sheet to a strong base prior to application of the finish coat.

47. A finish coated steel sheet article produced according to claims 1-46.

48. A process for applying a prime coating directly onto at least one surface of a continuous steel or metallic-coated steel sheet, comprising the steps of:
a) providing a length of continuous moving steel sheet;
b) forming a pristine metal-coated surface on the moving steel sheet; and
c) applying a prime coating on the moving pristine metal-coated surface of the moving steel sheet.

49. The process of claim 48, including the step of applying the prime coating with a roll coater.

50. The process of claim 49, including the step of providing a prime coating that is solvent borne, the solvent including an organic solvent.

51. The process of claim 49, including the step of providing a prime coating that is waterborne.

52. The process of claim 48, including the step of applying the prime coating using a thermal coating process.

53. The process of any one of claims 48-52, including the step of curing the prime coating using convection heating.

54. The process of any one of claims 48-52, including the step of curing the prime coating using induction heating.

55. The process of any one of claims 48-52, including the step of curing the prime coating using infrared (IR) radiation.

56. The process of any one of claims 48-52, including the step of curing the prime coating using a process selected from the group consisting of convection heating, induction heating, infrared (IR) radiation, and combinations thereof.

57. The process of claim 48, including the step of rinsing the steel sheet prior to application of the prime coating.

58. The process of claim 48, including the steps of rinsing and drying the steel sheet prior to application of the prime coating.

59. The process of any of claims 57 and 58, including the step of washing the steel sheet with a cleaning solution prior to the rinsing step.

60. The process of claim 48, including the step of pretreating the steel sheet prior to applying the prime coating.

61. The process of claim 48, including the steps of pretreating the steel sheet after applying a process selected from the group consisting of cleaning, rinsing, drying, and combinations thereof and prior to applying the prime coating.

62. The process of any one of claims 60 and 61, including the step of pretreating the steel sheet with a dried-in-place pretreatment.

63. The process of any one of claims 60 and 61, including the step of pretreating the steel sheet with a conversion coating.

64. A prime-coated steel sheet article produced according to claim 49.
